(19) United States
(12) Patent Application Publication
(10) Pub. No.: US 2018/0040083 A1
(43) Pub. Date: Feb. 8, 2018

(54) Creative Work Registry

(71) Applicant: James D. Bennett, Hroznetin (CZ)

(72) Inventor: James D. Bennett, Hroznetin (CZ)

(21) Appl. No.: 15/786,833

(22) Filed: Oct. 18, 2017

Related U.S. Application Data
(63) Continuation-in-part of application No. 14/321,109, filed on Jul. 1, 2014, now abandoned.
Application No. 14/321,109 is a continuation-in-part of application No. 13/665,693, filed on Oct. 31, 2012.
Application No. 13/665,693 is a continuation of application No. 12/482,586, filed on Jun. 11, 2009, now Pat. No. 9,535,993.
(60) Provisional application No. 61/841,874, filed on Jul. 1, 2013.
(60) Provisional application No. 61/060,650, filed on Jun. 11, 2008.

(51) Int. Cl. G06Q 50/18; G06F 21/62; G06F 21/10

(52) U.S. Cl. CPC G06Q 50/184; G06F 21/10; G06F 21/6209; G06F 21/6272

(57) ABSTRACT

A system and/or method substantially as shown and described with respect to at least the previous description, for copyright registration and/or screening.

### CROSS REFERENCES TO RELATED APPLICATIONS

This application is a continuation in part of U.S. patent application Ser. No. 14/321,109 filed on Jul. 1, 2014, which claims the benefit of priority to 61/841,874 filed on Jul. 1, 2013. This application is also a continuation in part of U.S. patent application Ser. No. 13/665,693 filed on Oct. 31, 2012, which is a continuation of U.S. patent application Ser. No. 12/482,586 filed on Jun. 11, 2009, which claims the benefit of priority to U.S. Provisional Application 61/060,650 filed on Jun. 11, 2008. Each of the above referenced documents is hereby incorporated herein by reference.

The present application is related to U.S. application Ser. No. 12/482,586, filed on Jun. 11, 2009; U.S. application Ser. No. 13/665,693, filed Oct. 31, 2012; and U.S. application Ser. No. 12/482,624 filed on Jun. 11, 2009; each of which is hereby incorporated herein by reference in its entirety for all purposes.

The present application is related to U.S. Provisional Application No. 61/060,650, filed Jun. 11, 2008; and U.S. Provisional Application Ser. No. 61/060,671, filed Jun. 11, 2008; each of which is hereby incorporated herein by reference in its entirety for all purposes.

### BACKGROUND

### 1. Technical Field

Various aspects of the present invention relate generally to Internet infrastructures; and, for example, to search engines. Various aspects of the present invention relate generally to Internet infrastructures; and, more particularly, to creative work protection.

### 2. Related Art

The frequent use of search engines by users of business, commercial, scientific and other professional organizations and home users to identify web links of web sites that provide information related to a keyword has made them one of the most widely used tools for accessing content of the Internet. They make the Internet far more useful to the users and have contributed to the growth of the Internet enormously. Many search engines provide additional services to the users besides searching for web pages, images, audio and video recordings. For example, some search engines provide services such as providing headlines of news, providing access to news item links from various political, business, scientific, and other professional reporting services.

Many third party servers provide services that allow users to post family audio, video, text and images anonymously or by registration and allow public to download or view these posted content. That is, these third party servers are specifically set up for public viewing, access and download. But some of the media stored and served thereby is copyrighted and belongs to respective owners. However, owners are not in a position to identify who is posting their copyrighted material and where it is posted.

Such posting may happen from anywhere around the world. The servers who accept these posting often do not know who posts what, except if specifically informed so. These servers enable unwittingly millions of people to be violators of copyright laws. Copyright owners spend tens of thousands of dollars to find out who posted their material, and may still not be successful. And if this occurs too often, it becomes extremely hard to follow these activities. To take this on is a huge job and the owners get very little in return. Many servers that accept posting of material have in principle mechanisms involved to erase these materials from their sites, but they don't work efficiently, and need to be monitored constantly. For example, the users may provide feedback regarding copyrighted material and the third party servers may delete them upon consideration.

In addition, many other minor web sites post unauthorized copyrighted audio, video, text, and image content that are extremely hard to identify. These web sites allow downloading and viewing of the content, making copyright owners face huge losses in return. The copyright owners are not in a position to identify these users, delete content from these major or minor web sites, or take any action against them because of the complexities and difficulties involved in such works.

Further, Many websites allow their users to, freely or upon some service charge, upload and post their family audio, video, texts and images and allow public to view or download these posted content. That is, these third party servers are specifically set up for public viewing, access, and download, with minimal supervision. But some of these media may be copyrighted, are posted without permission of the respective authors/artists. Some of these are major websites having multitude of postings, the websites themselves often are unable to identify copyright violations of authors/artists of some of these posted audio, video, texts and images content. The authors/artists also find it hard to constantly monitor these websites for violations of their rights.

There are many difficulties in identifying copyright violations that occur in these websites by their users. For example, the posting may happen from anywhere around the world and the authors/artists may have limited jurisdiction to follow upon these users located in remote locations of the world. The websites who accept these posting often do not know who posts what, except if specifically informed so. Thus these websites unwittingly enable millions of users to become violators of copyright laws. In addition, the postings constantly change, with new postings containing audio, video, texts and images content added every moment and thus making it necessary to monitor constantly.

Authors/artists spend huge sums to monitor violations of their works in these websites, and often end up unsuccessful in their efforts. Since, the website content constantly change, the authors/artists may have to monitor constantly, which makes effort as well as financial expenses prohibitive. To all these efforts the authors/artists often get very little in return. Many websites that accept posting of material have, in principle, mechanisms involved to erase these materials from their sites if they receive feedback from users, but they don't work efficiently, and need to be monitored constantly.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic block diagram illustrating an Internet infrastructure containing a client device, third party servers and a portion of a (web browser accessible) search engine server, wherein a portion of the search engine server provides protection for creative works containing text and images, by identifying similarities with web text and image content and reporting back to registered owners of the creative works;

FIG. 2 is a schematic block diagram illustrating an Internet infrastructure, in continuation of FIG.1, wherein a portion of the search engine server provides protection for creative works containing audio and video content, by identifying similarities with web audio and video content and reporting back to registered owners of the creative works;

FIG. 3 is a schematic block diagram illustrating components of a portion of the search engine server constructed in accordance with the embodiment of FIG. 1 of the present invention;

FIG. 4 is a schematic block diagram illustrating components of a portion of the search engine server constructed in accordance with the embodiment of FIG. 2, in continuation of FIG. 3, of the present invention;

FIG. 5 is an exemplary schematic block diagram illustrating a snap shot of a results page containing details of the creative work containing text and report of similarities in web content;

FIG. 6 is an exemplary schematic block diagram illustrating a snap shot of a results page containing details of the creative work containing video content and report of similarities in web content;

FIG. 7 is a flow diagram illustrating functionality of a portion of the search engine server of FIG. 1;

FIG. 8 is a flow diagram illustrating functionality of a portion of the search engine server of FIG. 1 in detail, with the creative work containing text in consideration;

FIG. 9 is a flow diagram illustrating functionality of a portion of the search engine server of FIG. 1 in detail, with the creative work containing images in consideration;

FIG. 10 is a flow diagram illustrating functionality of a portion of the search engine server of FIG. 2; and

FIG. 11 is a flow diagram illustrating functionality of a portion of the search engine server of FIG. 2 in detail, with the creative work containing audio-video content in consideration.

FIG. 12 is a schematic block diagram illustrating an Internet infrastructure containing a client device, major third party host servers and a (web browser accessible) creative work protection server, wherein the creative work protection server provides protection for creative works containing texts, images, video and audio recordings by identifying similarities with web content in the major third party host servers and database of the creative work protection server containing texts, images, video and audio recordings, respectively, and reporting back to registered owners of the creative works and major third party host servers;

FIG. 13 is an exemplary schematic block diagram illustrating snap shot of a registration/login page, that assists owners of creative works to register or login to the creative work protection server of FIG. 12;

FIG. 14 is an exemplary schematic block diagram illustrating snap shot of an upload page, that assists owners of creative works to upload their works to the creative work protection server of FIG. 12;

FIG. 15 is an exemplary schematic block diagram illustrating snap shot of a result page containing vital details of the creative work containing text and report of similarities in the respective content of database of the creative work protection server and of the major third party host servers of FIG. 12;

FIG. 16 is an exemplary schematic block diagram illustrating snap shot of a result page containing vital details of the creative work containing video content and report of similarities in the respective content of database of the creative work protection server and of the major third party host servers of FIG. 12;

FIG. 17 is a schematic block diagram illustrating components of the creative work protection server constructed in accordance with the embodiment of FIG. 12 of the present invention;

FIG. 18 is a schematic block diagram illustrating components of the creative work protection server constructed in accordance with the embodiment of FIG. 12, in continuation of FIG. 17;

FIG. 19 is a flow diagram illustrating functionality of the creative work protection server of FIG. 12, wherein the creative work protection server identifies and reports similarity in creative works containing textual content and images;

FIG. 20 is a flow diagram illustrating functionality of the creative work protection server of FIG. 12 in detail, with the creative work containing texts in consideration;

FIG. 21 is a flow diagram illustrating functionality of the creative work protection server of FIG. 12 in detail, with the creative work containing images in consideration;

FIG. 22 is a flow diagram illustrating functionality of the creative work protection server of FIG. 12 in detail, wherein the creative work protection server identifies and reports similarity in creative works containing audio and video content; and

FIG. 23 is a flow diagram illustrating functionality of the creative work protection server of FIG. 12 in detail, with the creative work containing audio-video content in consideration.

### DETAILED DESCRIPTION OF THE DRAWINGS

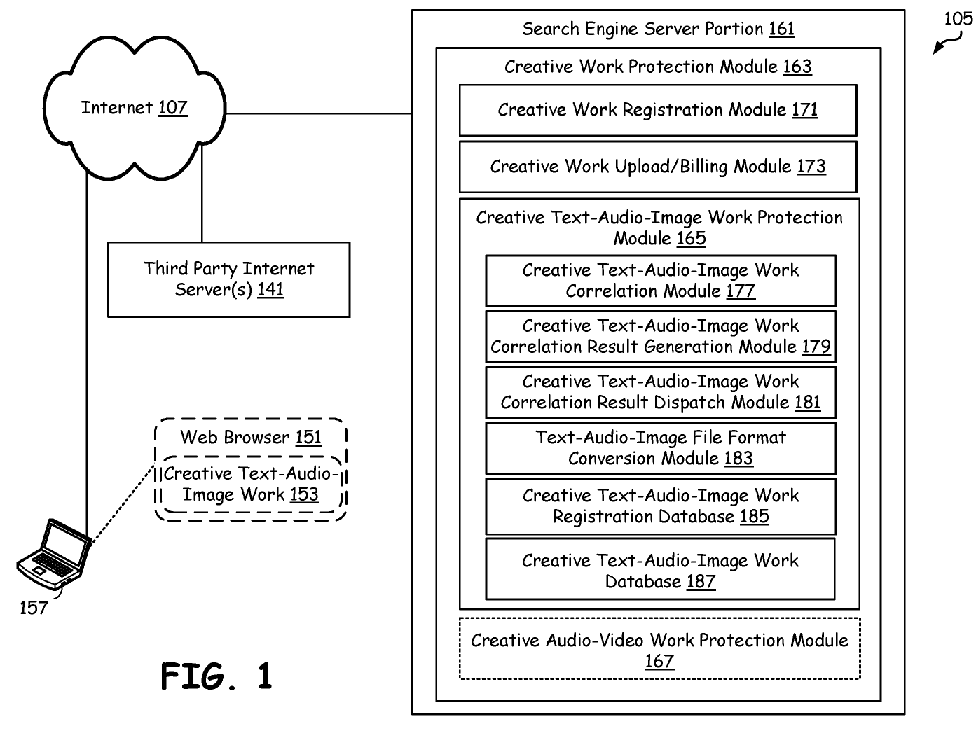

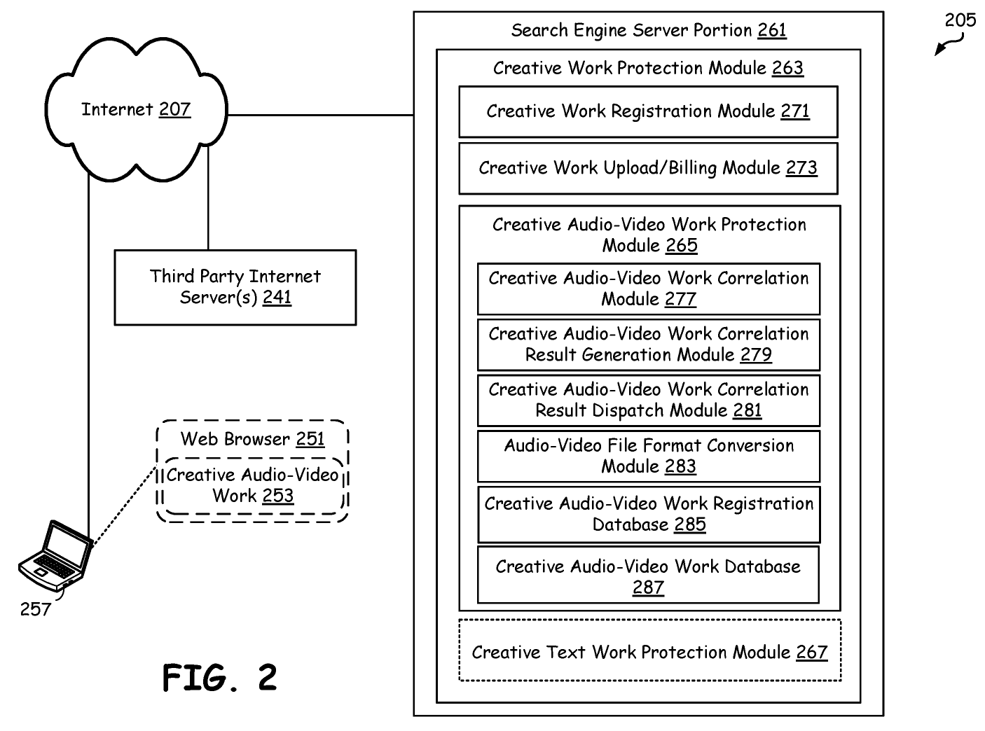

FIG. 1 is a schematic block diagram illustrating an Internet infrastructure 105 containing a client device 157, third party servers 141 and a portion of (web browser accessible) search engine server 161, wherein a portion of the search engine server 161 provides protection for creative works containing text and images 153, by identifying similarities with web text and image content and reporting back to registered owners of the creative works. The present invention relates to an additional value based copyright protection service from a search engine server (not shown). In specific, a portion of the search engine server (search engine server portion, hereafter) 161 provides protection to the creative works involving textual content, images 153 (and audio and video content, which are discussed with reference to the FIG. 2) by comparing the creative text-image works 153 with that of plurality of web content that contain textual content and/or images and generating report about results of comparison and reporting back to the registered owners of the creative text-image works 153.

This entire process of comparison with web content occurs during the crawling operation of the search engine server from web page to web page. The search engine server during crawling identifies textual content, audio content, and images in web pages as well as file attachments (such as one meant for downloading and viewing in a standard text reader) and submits the vectors of these web pages and file attachments to the search engine server portion 161. Thereafter, the search engine server portion 161 follows the vectors and identifies web pages and file attachments and compares the content with that of creative text-image works 153 of the registered owners. The search engine server, during crawling only submits those vectors to the web pages and file attachments that have not been compared before and the content have not been changed since last comparison.

The search engine server portion 161, in addition to reporting similarities back to the registered owners, also performs additional tasks such as reporting to the third party servers 141 regarding the possibility of copyright violations and also taking some actions such as assisting (with some arrangement with major host third party servers 141) to delete this web content, upon consideration that violate copyright laws.

The search engine server portion 161 provides web page interfaces to the owners of creative text-image works 153 that allow them to provide some personal information that may include user name, password, date of birth, address, email address, etc. Once registered, the owners of creative text-image works 153 are provided with web interfaces to login any time of their choice and upload their creative text-image works (the creative works may contain textual content alone, images alone or combinations of textual content, audio content, and images) 153 via web browser 151 to the search engine server portion 161. The creative text-image work files may be any of the standard text, image formats such as Microsoft Word format, Abode Reader format, ‘.jpeg’ format, and ‘.bmp’ format. The search engine server portion 161 stores these files in a database and converts them to a suitable format by separating text and images before further processing. In addition, once the creative text-image works 153 are uploaded, the search engine server portion 161 initiates a billing process based upon certain criteria. The billing may occur at the time of uploading or periodically. For example, the billing may be based upon a fixed price/creative text-image work 153, fixed price/number of characters in textual content of the creative text-image work 153, fixed price/image size/image of the creative text-image work 153, fixed price/report generated for a predetermined period such as a week or month, etc.

Once the creative text-image work 153 is acquired and stored, and once the billing process/agreement is completed, the search engine server portion 161 begins processing by segregating textual content, audio content, and images and then converting them to a standard predetermined format and again storing them. Then, based upon receiving of vectors from the search engine server during crawling, the processing by the search engine server portion 161 continues, by accessing the web text-image content or file attachments, storing them temporarily in a database. Then the search engine server portion 161 separates them into textual content, audio content, and images and converts these to the same predetermined format. Then, the search engine server portion 161 compares the textual content of converted creative text-image work with that of converted web text-image content and generates a report if similarities are identified. These reports are stored in a database. Also, for an additional fee, the search engine server portion 161 reports the similarities to the host thirds party servers 141 via some arrangement with these host third party servers 141 and automatically or by consideration assists in deleting these web text-image content.

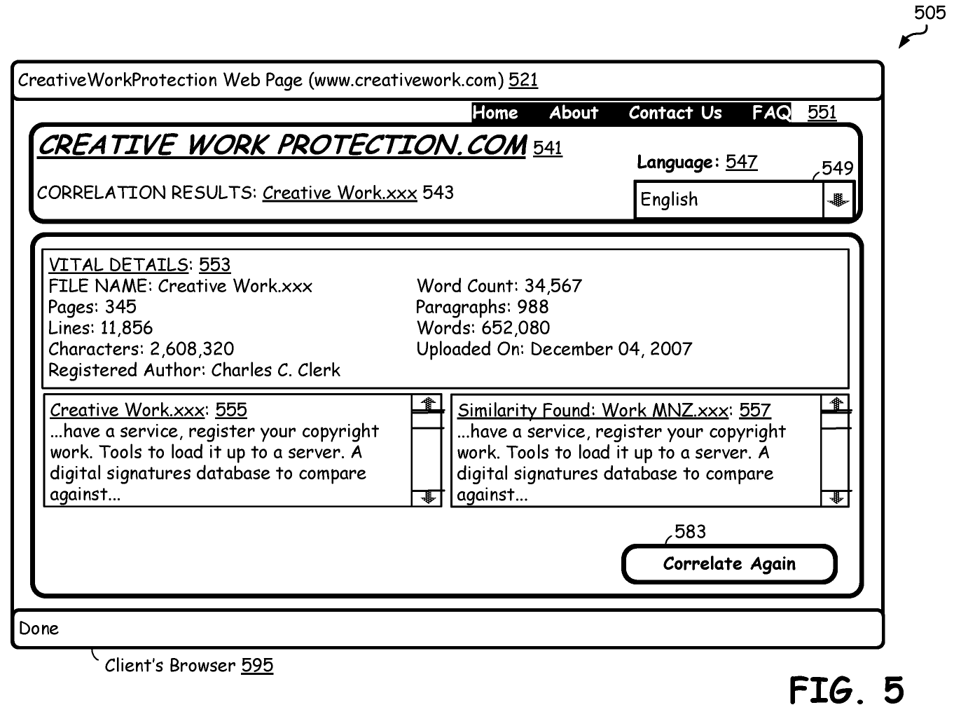

The comparison itself, between the textual content of converted creative text-image work and that of converted web text-image content occurs in many possible ways. The first among them is comparison of keywords or phrases (partially determined by the registered owner of the creative text-image work). This may be specifically applicable if the keywords or phrases are registered or copyrighted. Any matches would be considered as containing similarities. The second among these identifies number of words or number of sentences that contain similarities between the textual content by comparing character by character. The similarities are considered to be identified if the number of adjacent characters matches beyond a correlation threshold. The correlation threshold may be, for example, 20 adjacent characters or 20 adjacent words. Once this correlation threshold is exceeded, the search engine server portion 161 continues to compare until all of the similarities are identified and then generates a report on this basis (refer to the FIG. 5 for an exemplary snapshot of report). Other methods of comparison are also contemplated.

The correlation between the image content of converted creative text-image work and that of converted web text-image content occur on the basis of pixel by pixel comparison. The converted images are resized to a predetermined standard size and then are compared pixel by pixel for identifications of similarities. A correlation threshold may determine that a similarity is identified. Once this correlation threshold is exceeded (which might be number of adjacent pixels), for example, the search engine server portion 161 continues to compare until all of the similarities are identified and then generates a report on this basis. Other methods of comparison are also contemplated.

The search engine server portion 161 includes a plurality of modules to enable the functionalities mentioned in the above paragraphs. A creative work protection module 163 performs all of the above mentioned functions as well as providing copyright protection to registered owners of audio and/or video recordings (refer to the description of FIG. 2 for additional modules of the creative work protection module 163, as related to copyright protection of audio and video recordings). The creative work protection module 163 includes creative work registration module 171 and creative work upload/billing module 173 to perform functions of registration, logging in and billing. In addition, the creative work protection module 163 also includes two major modules, viz., creative text-image work protection module 165 and creative audio-video work protection module 167 (which is dealt in detail with reference to FIG. 2). The creative text-image work protection module 165 includes creative text-image work correlation module 177 which performs textual content and image comparisons, creative text-image work correlation result generation module 179 which generates reports, creative text-image work correlation result dispatch module 181 which delivers reports to the registered owners and/or host third party server 141 and text-image file format conversion module 183. The creative text-image work protection module 165 also includes databases to store information such as registration information and uploaded creative text-image works. The creative text-image work protection module 165 includes creative text-image work registration database 185 and creative text-image work database 187.

For example, an author of a copyrighted material (that includes several pages of written text and few images or diagrams), may want to protect his/her work being downloaded from third party servers 141. The author may not be aware of everything that goes on in third party servers 141 and may not know who is violating his/her rights. Therefore, the author may decide to register with the service of the search engine server. After registration, the author may upload an electronic version of his/her work in a standard file format and fulfill the service charge obligations.

Then, the search engine server portion 161 stores this file, segregates textual content from images or diagrams. The search engine server portion 161 then converts these textual content, audio content, and images or diagrams to a predetermined format. For example, the textual content may be converted to ‘.txt’ format while the diagrams or images may be converted to ‘.jpg’ format. Then, upon receiving vectors from the search engine server during crawling operation, the search engine server portion 161 begins to acquire the web content directed by the vectors and begins the comparison process. If no similarities are found, then no reports are generated and the process temporarily ends there.

On the contrary, if similarities are detected, then the search engine server portion 161 generates a report that may contain host third party server 141 details, vectors associated with the web content as well as the areas of similarity in textual content, audio content, and images and stores them in a database. Then, the accumulated reports over a predetermined period of time such as a day, week or month are formatted in a readable manner and submitted to the viewing of the author. The reports may be sent via email to the author, or may be made available on a webpage upon logging into the search engine server portion 161. If requests are made by the author for additional services such as sending reports to some major web sites that freely allow its users to post any material, the reports are generated and sent to these web sites for further consideration. The author, upon viewing the report may is able to identify these web sites which allow its users to view or download the copyrighted material without the author's permission and to take appropriate actions upon these violators.

FIG. 2 is a schematic block diagram illustrating an Internet infrastructure 205, in continuation of FIG.1, wherein a portion of the search engine server 261 provides protection for creative works containing audio and video content, by identifying similarities with web audio and video content and reporting back to registered owners of the creative works. Specifically, the search engine server portion 261 provides protection to the creative works involving creative audio-video works (copyrighted works containing audio recordings alone or audio and video recordings) 253 by comparing the creative audio-video works 253 with that of web content that contain downloadable or on-site-playable audio or video recordings and generating report about results of comparison and reporting back to the registered owners of the creative audio-video works 253.

This continuing process of comparison with web content occurs during the crawling operation of the search engine server (not shown). The search engine server, during crawling operation identifies audio and video recordings in web pages as well as file attachments (downloadable audio or video recordings from various artists or producers of music and movies, speech, educational audio-video material, professional organization related audio-video material, independent copyrighted audio-video material etc.) and submits the vectors of these web pages and file attachments to the search engine server portion 261. The search engine server portion 261 follows the vectors and identifies web pages and file attachments and compares the content with that of creative audio-video works 253 of the registered owners. The search engine server portion 261, during crawling, only submits those vectors to the web pages and file attachments that have not been compared before and the content have not been changed since last comparison. This web content containing audio-video recordings typically and mainly are located in major websites that allow free uploading and public access to the users of these sites, while some other minor websites may also make audio and video recordings available for the public, some of which may be unauthorized. By direct or tacit agreement with many of these major sites, the search engine server portion 261 is able to provide additional services to the registered owners of the creative audio-video works 253 such as reporting to the third party servers 241 regarding the possibility of copyright violations and also assisting to delete these unauthorized web content, upon consideration.

The search engine server portion 261 provides web page interfaces to the owners of creative audio-video works 253 that allow them to register one time initially by providing requested information, login at any time thereafter and upload their creative audio-video works 253 using a web browser 251 from the client device 257. The creative audio-video work files may be any of standard audio or video formats such as MP3, WMA, WAV, OGG, AVI, MPEG-1, MPEG-2, and WMV. The search engine server portion 261 stores these files in a database and converts them to a suitable format by: (i) In case of audio, to a predetermined audio format such as WAV; and (ii) In case of video, by separating audio and video portions and then converting them to a predetermined audio and video formats such as WAV and MPEG-2 respectively. In addition, once the creative audio-video works 253 are uploaded, the search engine server portion 261 initiates a billing process based upon certain criteria. The billing may occur at the time of uploading or periodically. For example, the billing may be based upon a fixed price/creative audio work, fixed price/creative video work, fixed price/minute of the creative audio-video work, fixed price/report generated for a predetermined period such as a week or month, etc.

Next, upon receiving vectors from the search engine server during crawling, the processing by the search engine server portion 261 continues by accessing the web audio or video content or file attachments, storing them temporarily in a database. Then the search engine server portion 261, in case of audio recordings, converts them to the same predetermined format that was used in case of creative audio work. In case of video recordings, the search engine server portion 261 separates audio and video portions converts them to the same predetermined formats that were used in case of creative video work. Then, the search engine server portion 261 compares the audio or video content of converted creative audio-video work with that of converted web audio-video content and generates a report if similarities are identified. These reports are stored in a database. Also, for an additional fee, the search engine server portion 261 reports the similarities to the host thirds party servers 241 via some arrangement with these host third party servers 241 and automatically or by consideration assists in deleting these web audio-video content. Alternatively, the search engine server portion 261 may also provide provisions for fees for each upload and download of the web audio-video content available in third party servers 241.

In case of audio recordings, the comparison occurs in many possible ways. The first among them is bit by bit comparison. The similarities are considered to be identified if the number of adjacent bits matches beyond a correlation threshold. The correlation threshold may be, for example, 256 adjacent bits. Once this correlation threshold is exceeded, the search engine server portion 261 continues to compare until all of the similarities are identified and then generates a report on this basis. Alternatively, to identify those web audio content having similarities, that are manipulated in someway (such as recording using a microphone), the search engine server portion 261 may resort to converting the recordings to analog forms and then comparing them. Other methods of comparison are also contemplated.

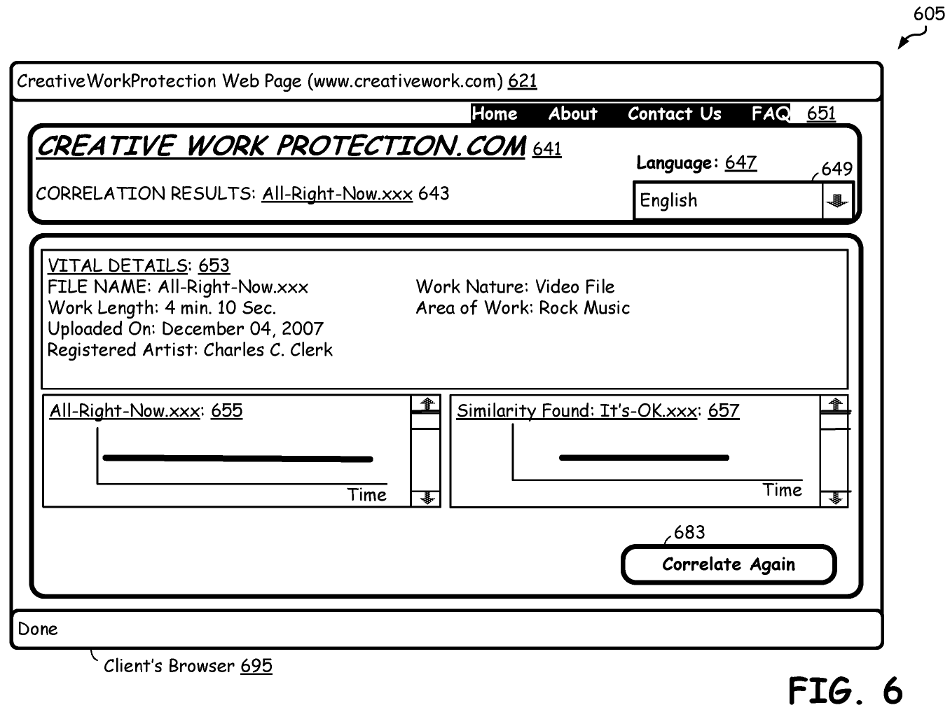

In case of video recordings, the digital signatures are identified and compared as a first step. As a next step, the comparison of audio portion of the video recording is performed, which occurs in a similar fashion as the comparison that occurs in case of audio recordings mentioned before. If no similarities are found, the video portions of the recording are compared. This occurs on the basis of frame by frame comparison. The similarities are considered to be identified if the number of adjacent frames matches beyond a correlation threshold. The correlation threshold may be, for example, 256 adjacent frames. Once this correlation threshold is exceeded, the search engine server portion 261 continues to compare until all of the similarities are identified and then generates a report on this basis. Other methods of comparison are also contemplated. The reports may be presented in case of both audio and video recordings, in a graphical manner (refer to the FIG. 6 for an exemplary snapshot of report).

The search engine server portion 261 includes a plurality of modules to enable the functionalities mentioned in the above paragraphs. A creative work protection module 263 (163 in FIG. 1) performs all of the above mentioned functions as well as providing copyright protection to registered owners of textual content and/or images (refer to the description of FIG. 1 for additional modules of the creative work protection module 263, as related to copyright protection of textual content, audio content, and images). The creative work protection module 263 includes creative work registration module 271 (171 in FIG. 1) and creative work upload/billing module 273 (173 in FIG. 1) to perform functions of registration, logging in and billing.

The creative work protection module 263 also includes two major modules, viz., creative text-image work protection module 267 (165 in FIG. 1) and creative audio-video work protection module 265. The creative audio-video work protection module 265 includes creative audio-video work correlation module 277 which performs audio and video comparisons, creative audio-video work correlation result generation module 279 which generates reports, creative audio-video work correlation result dispatch module 281 which delivers reports to the registered owners and/or host third party server 241 and audio-video file format conversion module 283. The creative audio-video work protection module 265 also includes creative audio-video work registration database 285 and creative audio-video work database 287.

For example, an artist of copyrighted rock music may want to prevent his/her work being downloaded (or played) from the third party servers 241 without permission. Therefore, the artist may decide to register with the creative work protection service of the search engine server. After registration, the artist may upload, for example, a WAV format recording of the rock music and fulfill the service charge obligations. Alternatively, the search engine server portion 261 also allows the artist to upload the rock music in many possible formats.

Then, the search engine server portion 261 stores the rock music file. The search engine server portion 261 then converts this recording to a predetermined format. Then, upon receiving vectors of the audio content from the search engine server during crawling operation, the search engine server portion 261 begins to acquire the audio content directed by the vectors and begins the comparison process. If no similarities are found, then no reports are generated and the process temporarily ends there. On the contrary, if similarities are detected, then the search engine server portion 261 generates report that may contain host third party server 241 details, vectors associated with the audio content as well as the areas of similarity in the rock music and stores them in a database. Then, the accumulated reports over a predetermined period of time such as a day, week or month are formatted in a readable manner and submitted to the viewing of the artist, either via email or via webpage interface upon logging into the search engine server portion 261. If requests are made by the artist for additional services such as sending reports to some major web sites that freely allow its users to post audio recordings, the reports are generated and sent to these web sites for further consideration. The artist, upon viewing the report may is able to identify these web sites which allow its users to view or download the rock music without the author's permission and to take appropriate actions upon these violators.

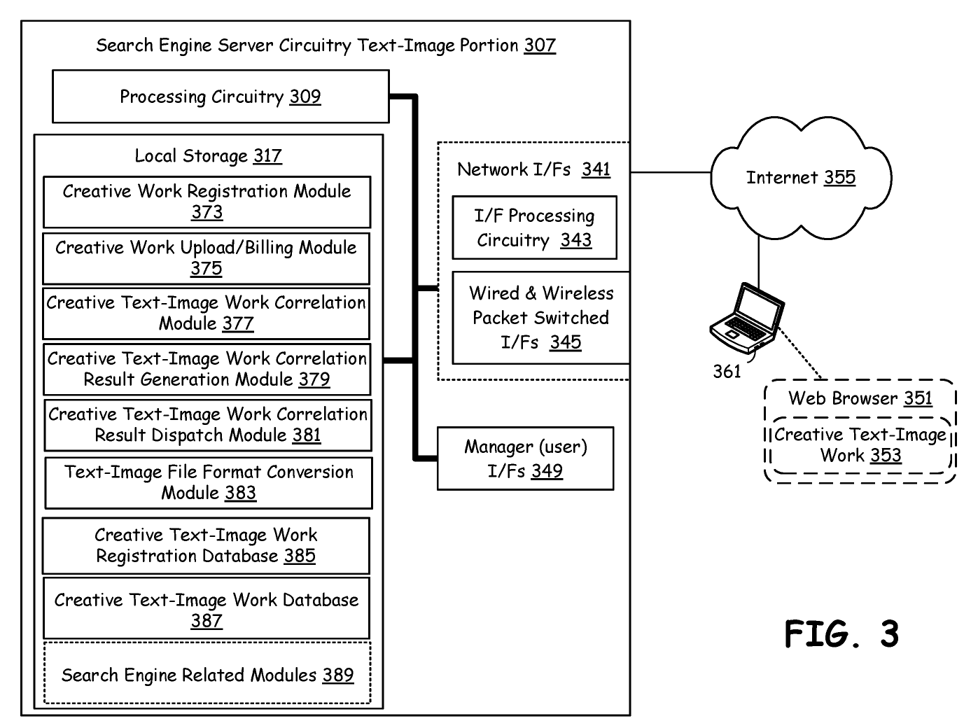

FIG. 3 is a schematic block diagram illustrating components of a portion of the search engine server 307 constructed in accordance with the embodiment of FIG. 1 of the present invention. Search engine server circuitry text-image portion 307 may in part or full be incorporated into any computing device that operates as an Internet based server. The search engine server circuitry text-image portion 307 generally includes processing circuitry 309, local storage 317, manager interfaces 349, and network interfaces 341. These components communicatively couple to one another via one or more of a system bus, dedicated communication pathways, or other direct or indirect communication pathways. The processing circuitry 309 may be, in various embodiments, a microprocessor, a digital signal processor, a state machine, an application specific integrated circuit, a field programming gate array, or other processing circuitry.

Local storage 317 may be random access memory, read-only memory, flash memory, a disk drive, an optical drive, or another type of memory that is operable to store computer instructions and data. The local storage 317 stores/instantiates instructions/data that support the creative work registration module 373 and the creative work upload/billing module 375 to perform functions of registration, logging in and billing. Each of the modules described herein (not limited to the modules described in FIG. 3) may be instantiated by hardware, software, and/or a combination of hardware and software. In addition, the local storage 317 stores instructions/data that support the creative text-image work correlation module 377, which performs textual content and image comparisons, creative text-image work correlation result generation module 379 which generates reports, creative text-image work correlation result dispatch module 381 which delivers reports to the registered owners and/or host third party server (not shown) and text-image file format conversion module 383. The local storage 317 also includes creative text-image work registration database 385 to store registration, logging in and billing information of the registered owners and creative text-image work database 387 to store creative text-image work 353 of registered owners. In addition, the illustration shows search engine related modules 389 that perform search engine operations.

The network interfaces 341 contain wired and wireless packet switched interfaces 345 and may also contain built-in or an independent interface processing circuitry 343. The network interfaces 341 allow the search engine server circuitry text-image portion 307 to communicate with client devices such as 361 and to upload creative text-image works 353 via a web browser 351 and to deliver results. The manager interfaces 349 may include a display and keypad interfaces. These manager interfaces 349 allow the user at the search engine server circuitry text-image portion 307 to control aspects of the present invention. The client device 361 illustrated are communicatively coupled to the search engine server circuitry text-image portion 307 via an Internet 355.

In other embodiments, the search engine server circuitry text-image portion 307 of the present invention may include fewer or more components than are illustrated as well as lesser or further functionality. In other words, the illustrated search engine server circuitry text-image portion is meant to merely offer one example of possible functionality and construction in accordance with the present invention.

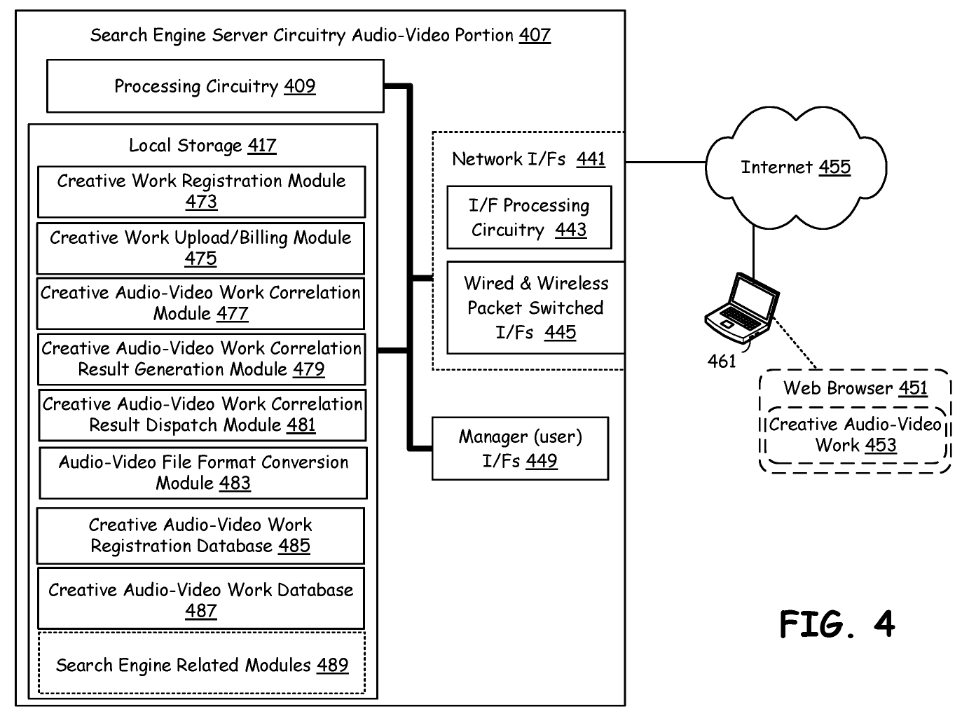

FIG. 4 is a schematic block diagram illustrating components of a portion of a search engine server constructed in accordance with the embodiment of FIG. 2, in continuation of FIG. 3, of the present invention. Search engine server circuitry audio-video portion 407 may in part or full be incorporated into any computing device that operates as an Internet based server. The search engine server circuitry audio-video portion 407 generally includes processing circuitry 409 (309 of FIG. 3), local storage 417 (317 of FIG. 3), manager interfaces 449 (349 of FIG. 3) and network interfaces 441 (341 of FIG. 3). These components communicatively couple to one another via one or more of a system bus, dedicated communication pathways, or other direct or indirect communication pathways. The processing circuitry 409 may be, in various embodiments, be a microprocessor, a digital signal processor, a state machine, an application specific integrated circuit, a field programming gate array, or other processing circuitry.

Local storage 417 may be random access memory, read-only memory, flash memory, a disk drive, an optical drive, or another type of memory that is operable to store computer instructions and data. The local storage 417 stores instructions/data to instantiate at least part of creative work registration module 473 (373 of FIG. 3) and creative work upload/billing module 475 (375 of FIG. 3) to perform functions of registration, logging in and billing. In addition, the local storage 417 stores instructions/data to instantiate at least a portion of creative audio-video work correlation module 477 which performs audio and video content comparisons between creative audio-video work 453 of registered owners and audio-video content of third party servers (not shown), creative audio-video work correlation result generation module 479 which generates reports, creative audio-video work correlation result dispatch module 481 which delivers reports to the registered owners and/or host third party server and audio-video file format conversion module 483. The local storage 417 also stores instructions/data to instantiate at least a portion of creative audio-video work registration database 485 to store registration, logging in and billing information of the registered owners and creative audio-video work database 487 to store creative audio-video work 453 of the registered owners. In addition, the illustration shows search engine related modules 489 that perform search engine operations.

The network interfaces 441 contain wired and wireless packet switched interfaces 445 and may also contain built-in or an independent interface processing circuitry 443. The network interfaces 441 allow the search engine server circuitry audio-video portion 407 to communicate with client devices such as 461 and to upload creative audio-video works 453 via a browser 451 and to deliver results. The manager interfaces 449 may include a display and keypad interfaces. These manager interfaces 449 allow the user at the search engine server circuitry audio-video portion 407 to control aspects of the present invention. The client device 461 illustrated are communicatively coupled to the search engine server circuitry audio-video portion 407 via Internet 455.

In other embodiments, the search engine server circuitry audio-video portion 407 of the present invention may include fewer or more components than are illustrated as well as lesser or further functionality. In other words, the illustrated search engine server circuitry audio-video portion is meant to merely offer one example of possible functionality and construction in accordance with the present invention.

FIG. 5 is an exemplary diagram illustrating a snap shot of a results page containing details of a creative work containing text and reporting of similarities in web content. Specifically, the exemplary snap shot illustrated shows a creative text work correlation (comparison) results page 505 delivered to a client's browser 595 of client device, containing statistics of the creative text work and selected portions of text that are similar. The creative text work correlation results page 505 delivered may contain a page title such as ‘CreativeWorkProtection Web Page (www.creativework.com)’ 521. It may also contain a title such as ‘CREATIVE WORK PROTECTION.COM’ 541 and a tool bar 551 providing access to other pages of the search engine server portion. A language 547 selection tool 549 may also be provided, that allows user to choose a language in the results pages. A sub-title that provides the name of the creative text work in consideration such as ‘CORRELATION RESULTS: Creative Work.xxx’ 543 may also be provided.

One of the windows in the creative text work correlation (comparison) results page 505 may provide statistics of the creative text work in consideration such as ‘DETAILS:’ 553 followed by details such as file name, word count, number of pages, number of paragraphs, number of lines, number of words, number of characters, uploaded on and registered author. Additional statistics related to the web text content or file attachments in which the similarity is found such as web site, web page/file attachment link, web page/file statistics and the locations within the web page/file where similarity is found may also be provided in this window (not shown).

A second window illustrated provides the file name of the creative text work of a registered owner such as ‘Creative Work.xxx:’ 555 followed by the text where similarities are found. A third window illustrated provides the file name of the web text content posted by a third party server such as ‘Similarity Found: Work MNZ.xxx:’ 557 followed by the text that contains the similarities. The author may be able to decide whether to ignore the similarity found or to take any necessary actions. Also, a ‘Correlate Again’ button 583 provides options to the author to continue to the next similarity either within the current web page/file text content or in another web page/file.

FIG. 6 is an exemplary diagram illustrating a snap shot of a results page 605 containing details of the creative work containing video content and a report of similarities in web content. In specific, the exemplary snap shot illustrated shows a creative video work correlation (comparison) results page 605 delivered to a client's browser 695 of client device, containing statistics of the creative video work and graphical representation of areas of similarity. The creative video work correlation results page 605 delivered may contain a page title such as ‘CreativeWorkProtection Web Page (www.creativework.com)’ 621. It may also contain a title such as ‘CREATIVE WORK PROTECTION.COM’ 641 and a tool bar 651 providing access to other pages of the search engine server portion. A language 647 selection tool 649 may also be provided, that allows user to choose a language in the results pages. A sub-title that provides the name of the creative video work in consideration such as ‘CORRELATION RESULTS: All-Right-Now.xxx’ 643 may also be provided.

A first window in the creative video work correlation (comparison) results page 605 may provide statistics of the creative video work in consideration such as ‘DETAILS:’ 653 followed by details such as file name, work nature, work length, area of work, uploaded on and registered artist. Additional statistics related to the web video content or file attachments in which the similarity is found such as web site, web video content/file attachment link, web video content/file statistics and the locations within the web video content/file where similarity is found may also be provided in this window (not shown).

A second window illustrated provides the file name of the creative video work of a registered owner such as ‘All-Right-Now.xxx:’ 655 followed by some graphical representation of the length of the creative video work. A third window illustrated provides the file name of the web video content/file attachment posted by a third party server such as ‘Similarity Found: It's-OK.xxx:’ 657 followed by a graphical representation similar to that of the second window depicting the areas where similarity found. The artist is able to take necessary actions based upon observation of displayed similarities. Also, a ‘Correlate Again’ button 683 provides options to the artist to continue to the next similarity in another web video content/file.

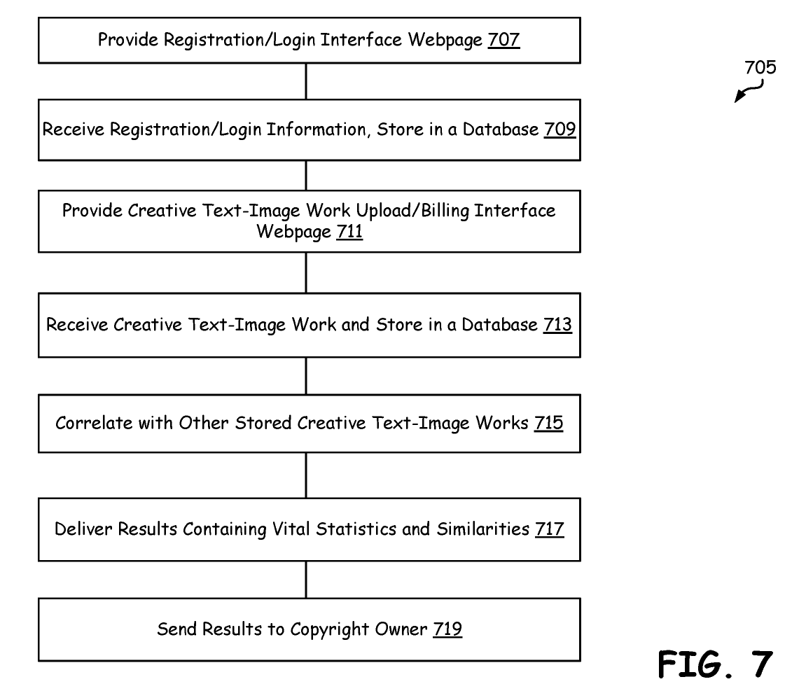

FIG. 7 is a flow diagram illustrating functionality 705 of a portion of the search engine server of FIG. 1. The functionality of a portion of the search engine server (hereafter, search engine server portion) begins at a block 707 when an owner of a creative text-image work is provided with registration/login interface webpage. At a next block 709, the search engine server portion receives registration information if the owner is interacting with the search engine server portion for the first time and stores this information in a database. In subsequent interactions, the search engine server portion verifies login information and allows the owner to access services of the search engine server portion. The registration information may contain user name, password, date of birth, address, email address and other relevant information.

At a next block 711, the search engine server portion provides creative text-image work upload/billing interface. The owner may upload any number of creative text-image works in subsequent visits (after initial registration), and the billing may occur on one of many possible ways. This includes a fixed price/creative text-image work, fixed price/number of characters in textual content of the creative text-image work, fixed price/image size/image of the creative text-image work, fixed price/report generated for a predetermined period such as a week or month, etc. That is, the billing may occur immediately after uploading of creative text-image works or may occur periodically based upon an agreement with the registered owner. And the service may be provided for a fixed period of time such as one year or two years depending upon agreement with the registered owner.

At a next block 713, the search engine server portion receives creative text-image works and stores them in a database. At a next block 715, the search engine server portion correlates the creative text-image work with that of web content, vectors of which are delivered by the search engine server during crawling operation. Then, search engine server portion generates a report containing all of the website links (together with vectors of web pages or files contained in the web sites) that contain text or images having similarities with that of content of creative text-image works. At a next block 717, the search engine server portion delivers results containing statistics of the creative text-image works, along with similarities found. In a final block 719, the search engine server portion sends results to the registered owner, and upon agreement with registered owner and host third party servers, to the host third party servers.

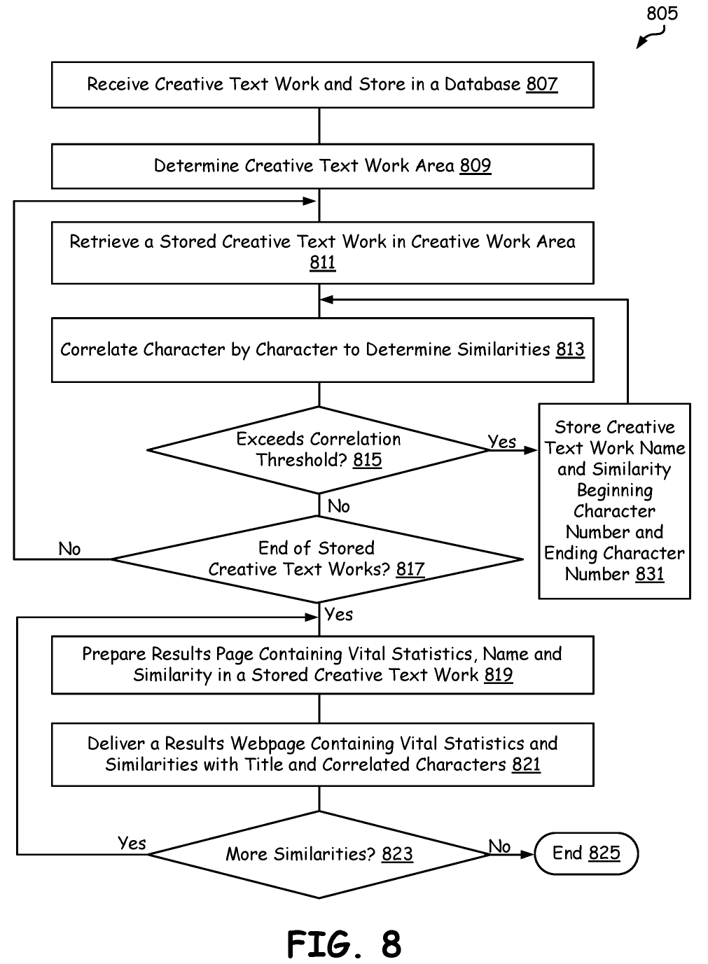

FIG. 8 is a flow diagram illustrating functionality of a portion of the search engine server of FIG. 1 in detail, with the creative work containing text in consideration. The detailed functionality concerning creative text works of a registered owner begins at a block 807, where the search engine server portion receives creative text works and stores them in a database. To make this possible, the search engine server portion provides webpage interfaces to the registered owner to upload one or more creative text works. At a next block 809, the search engine server portion determines the area of the creative text work. For example, the area may be photographs, art work, paintings, pictures of cartoon characters etc. This is optional, if the registered owner provides such information and in this case the search engine server portion may not compare with web text content of web sites that do not belong to the area of creative text work.

At a next block 811, the search engine server portion retrieves stored creative text work in a given text area. At a next block 813, the search engine server portion correlates character by character with that of web text content to determine similarities. At a next decision block 815, the search engine server portion determines if the similarities exceed a predetermined correlation threshold. If yes, then the search engine server portion stores creative text work name along with web page details and similarity beginning character number and ending character number, at a next block 831. Then, the processes of blocks 813 and 815 are repeated. If not at the decision block 815, at a next decision block 817, the search engine server portion determines if all of the creative text works of the registered owner are compared. If not, with a next creative text work, the processes of blocks 811, 813, 815 and 831 are repeated. In another embodiment, the comparison may occur on the basis of keywords, which is not shown in the flowchart.

If yes at the decision block 817, then the search engine server portion prepares a results page (from the stored information of similarities) containing statistics, name and web links of the text that contains similarities along with additional information, at a next block 819. Then, at a next block 821, the search engine server portion delivers the results page containing statistics and similarities with title and correlated characters. At a next decision block 823, the search engine server portion determines if more similarities within the same webpage or in another webpage (that belongs to the creative text works of the registered owner) are found. If yes, then the processes of blocks 819 and 821 are repeated to generate addition results pages. If not, at a final block 825, the functionality ends.

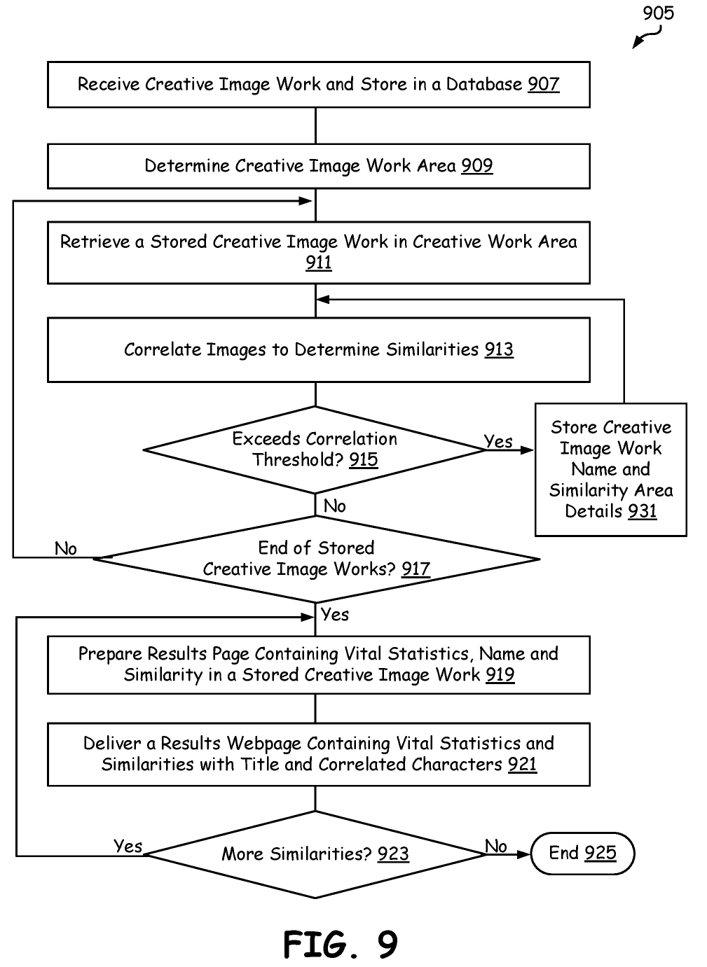

FIG. 9 is a flow diagram illustrating functionality 905 of a portion of the search engine server of FIG. 1 in detail, with the creative work containing images in consideration. The detailed functionality concerning creative image works begins at a block 907, where the search engine server portion receives creative image works and stores them in a database. The search engine server portion provides webpage interfaces to a registered owner of the creative image works to upload one or more creative image works. At a next block 909, the search engine server portion determines the area of the creative image work. For example, the area may be photographs, art work, paintings, pictures of cartoon characters etc. The area of the creative image work is determined only if the registered owner provides such information. In this case, the search engine server portion may not compare with web image content that do not belong to the area of creative image work.

At a next block 911, the search engine server portion retrieves stored creative image work in a given image area. At a next block 913, the search engine server portion correlates images pixel by pixel (after converting formats to a predetermined image format and resizing the images) with that of web image content to determine similarities. At a next decision block 915, the search engine server portion determines if the similarities exceed a predetermined correlation threshold. If yes, then the search engine server portion stores creative image work name along with web page details and similarity area details, at a next block 931. Then, the processes of blocks 913 and 915 are repeated. If not at the decision block 915, at a next decision block 917, the search engine server portion determines if all of the creative image works of the registered owner are compared. If not, with a next creative image work, the processes of blocks 911, 913, 915 and 931 are repeated.

If yes at the decision block 917, then the search engine server portion prepares a results page (from the stored information of similarities) containing statistics, name and web links of the image that contains similarities along with additional information, at a next block 919. Then, at a next block 921, the search engine server portion delivers the results page containing statistics and similarities with title and correlated image areas. At a next decision block 923, the search engine server portion determines if more similarities within the same webpage image or in another webpage image are found. If yes, then the processes of blocks 919 and 921 are repeated to generate addition results pages. If not, at a final block 925, the functionality ends.

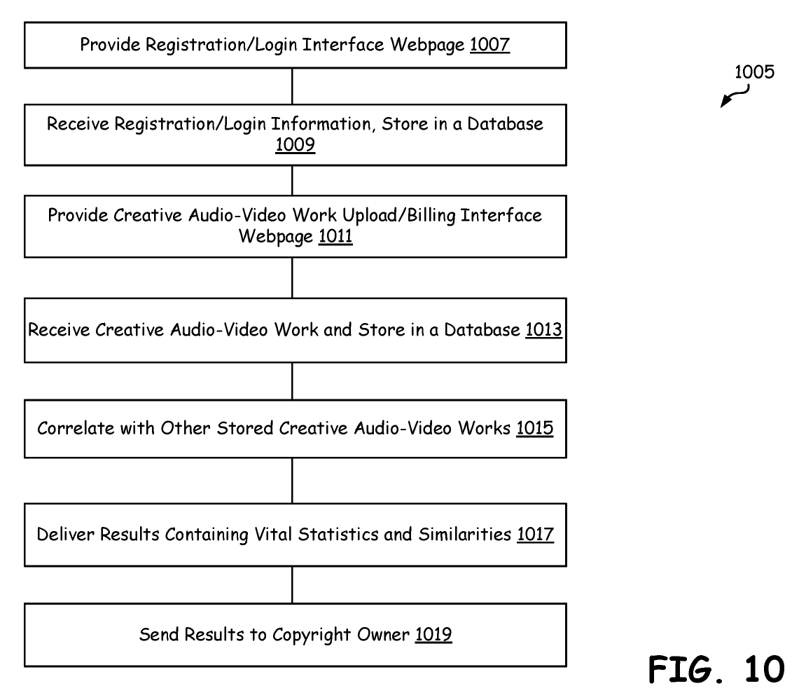

FIG. 10 is a flow diagram illustrating functionality 1005 of a portion of the search engine server of FIG. 2. The functionality of a portion of the search engine server (hereafter, search engine server portion) begins at a block 1007 when an owner of a creative audio-video work is provided with registration/login interface webpage. At a next block 1009, the search engine server portion receives registration information (for the first time) and stores this information in a database. In subsequent interactions, the search engine server portion verifies login information and allows the owner to access services of the search engine server portion. The registration information may contain user name, password, date of birth, address, email address and other relevant information.

At a next block 1011, the search engine server portion provides creative audio-video work upload/billing webpage interface. The owner may upload any number of creative audio-video works in subsequent visits (after initial registration), and the billing may occur on one of many possible ways. This includes a fixed price/creative audio-video work, fixed price/second of the creative audio-video work, fixed price/report generated for a predetermined period such as a week or month, etc. That is, the billing may occur immediately after uploading of creative audio-video works or may occur periodically based upon an agreement with the registered owner. The service may be provided for a fixed period of time such as one year or two years depending upon agreement with the registered owner.

At a next block 1013, the search engine server portion receives creative audio-video works and stores them in a database. At a next block 1015, the search engine server portion correlates the creative audio-video work with that of web content, vectors of which are delivered by the search engine server during crawling operation. Then, search engine server portion generates a report containing all of the website links that contain audio-video content having similarities with that of content of creative audio-video works. At a next block 1017, the search engine server portion delivers results containing statistics of the creative audio-video works, along with similarities found. In a final block 1019, the search engine server portion sends results to the registered owner, and upon agreement with registered owner and host third party servers, to the host third party servers.

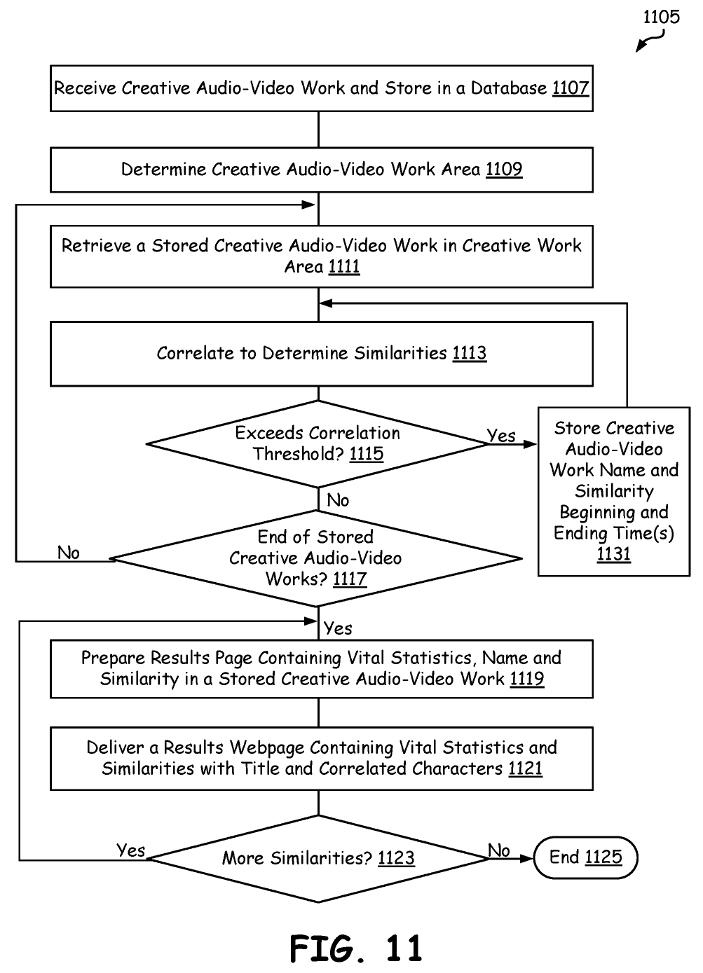

FIG. 11 is a flow diagram illustrating functionality 1105 of a portion of the search engine server of FIG. 2 in detail, with the creative work containing audio-video content in consideration. The detailed functionality concerning creative audio-video works begins at a block 1107, where the search engine server portion receives creative audio-video works and stores them in a database. The search engine server portion provides webpage interfaces to registered owner of the creative audio-video works to upload one or more creative audio-video works. At a next block 1109, the search engine server portion determines the area of the creative audio-video work. For example, the area may be: (i) In case of creative audio works—rock music, country music, regional music belonging to various categories, etc. and (ii) In case of video works—motion pictures, educational material, personal videos etc. The area of the creative audio-video work is determined only if the registered owner provides such information. In this case, the search engine server portion may not compare with web audio-video content that does not belong to the area of creative audio-video work.

At a next block 1111, the search engine server portion retrieves stored creative audio-video work in a given audio-video area. At a next block 1113, the search engine server portion correlates audio-video works with that of web audio-video content to determine similarities. In case of audio recordings, bit by bit comparison may be employed. Alternatively, in some cases, the search engine server portion may resort to converting the recordings to analog forms and then comparing them. In case of video recordings, the digital signatures are identified and compared as a first step. As a next step, the comparison of audio portion of the video recording is performed and then, if no similarities are found, the video portion of the recording are compared. The video portion comparison may occur on the basis of frame by frame comparison. Other methods of comparison are also contemplated. The reader should understand that by comparing audio portions of audio-video content, correlation between works may be relatively easily determined. Such comparison provides an efficient mechanism for determining if motion pictures illegally reside upon a server for example, without requiring a video content to video content comparison, which may not be effective due to differences in format sizes, resolutions, frame rates, etc. When comparing audio portions of audio-video content, digital information of an audio bit stream may be compared. Alternately, the audio portion of two (or more) audio-video files may be converted to the frequency domain and the two (or more) audio portions may be compared.

At a next decision block 1115, the search engine server portion determines if the similarities exceed a predetermined correlation threshold. In case of audio recordings (or audio portions of audio-video recordings), the correlation threshold may be a predetermined number of adjacent bits, spectral component samples, and in case of video this may be a predetermined number of adjacent frames. If yes at the decision block 1115, then the search engine server portion stores creative audio-video work name, vectors for web audio-video content along with similarity beginning and ending times, at a next block 1131. Then, the processes of blocks 1113 and 1115 are repeated. If not at the decision block 1115, at a next decision block 1117, the search engine server portion determines if all of the creative audio-video works of the registered owner are correlated. If not, with a next creative audio-video work, the processes of blocks 1111, 1113, 1115 and 1131 are repeated.

If yes at the decision block 1117, then the search engine server portion prepares a results page (from the stored information of similarities) containing statistics, name and web links of the audio-video content that contains similarities along with additional information, at a next block 1119. Then, at a next block 1121, the search engine server portion delivers the results page containing statistics and similarities with title and correlated audio-video times. At a next decision block 1123, the search engine server portion determines if more similarities within the same audio-video content or in another audio-video content are found. If yes, then the processes of blocks 1119 and 1121 are repeated to generate addition results pages. If not, at a final block 1125, the functionality ends.

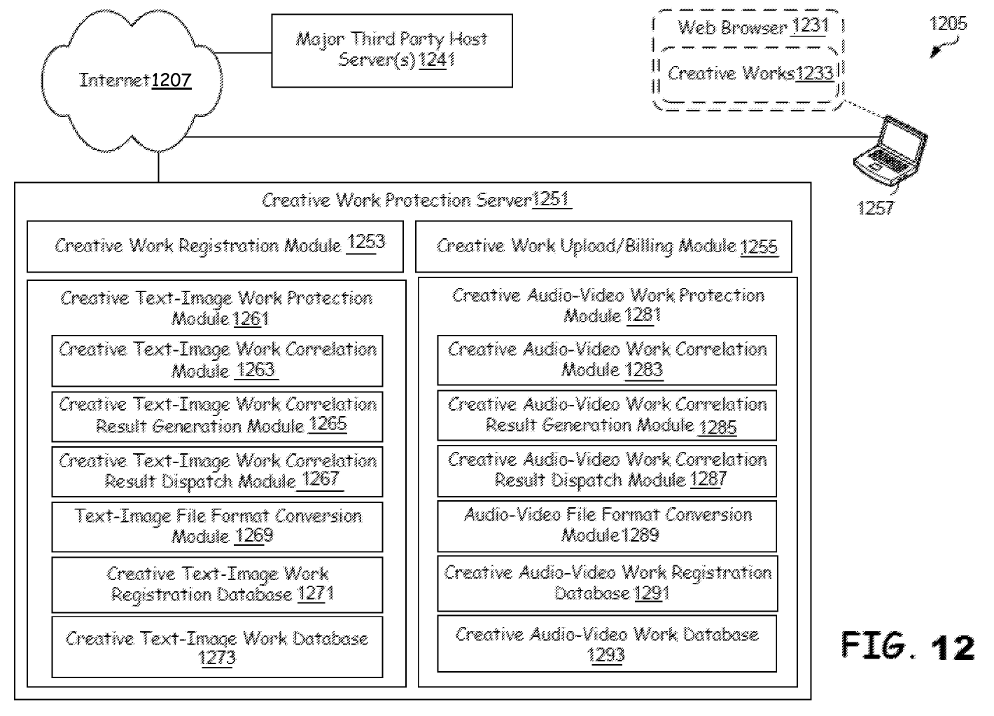

Various additional aspects of the present invention will now be presented with reference to FIGS. 12-23. Note that the following discussion will present various aspects that may be stand-alone aspects, or that may combine with any or all aspects discussed previously with regard to FIGS. 1-11.

The following figures illustrate various embodiments of creative works infrastructures that support creative works rights protection, revenue collection, and user, author, owner interfacing. Creative works may be textual, images, video, audio and video with associated audio. In each of the embodiments, attempts are made to identify copies or derivatives of such creative works and to identify unauthorized attempts of storage or distribution and, if so configured, offer licensing and associated fee collection. An author/owner need only register at least some portion of their creative works into some type of registry database and comparisons may be made with a user's file or stream.

FIG. 12 is a schematic block diagram illustrating an Internet infrastructure 105 containing a client device 1257, major third party host servers 1241 and a (web browser accessible) creative work protection server 1251, wherein the creative work protection server 1251 provides protection for creative works 1233 containing texts, images, video and audio recordings by identifying similarities with web content in the major third party host servers 1241 and database of the creative work protection server 1251 containing texts, images, video and audio recordings, respectively, and reporting back to registered owners of the creative works and major third party host servers 1241. Specifically, the creative work protection server 1251 provides protection to the creative works 1233 (belonging to registered users of the creative work protection server 1251), involving textual content, images, audio and video content, by comparing the creative works 1233 with that of other creative works stored in database of the creative work protection server 1251 and the major third party host servers 1241, and generating report about results of comparison and reporting back to the registered owners of the creative works 1233 and to the major third party host servers 1241.

Typically, the comparison takes place only between similar content, both with the creative works in database of the creative work protection server 1251 and plurality of the major third party host servers 1241. That is, textual content of the creative works 1233 are compared only with other textual content, video recordings are compared only with other video content, and so on. During comparison, any similarities between the content of the creative works 1233 and that of content of database of the creative work protection server 1251 and plurality of the major third party host servers 1241 imply likelihood of infringements of the rights of the registered owner and are reported back, for further actions. The process of comparison with plurality of web content in major third party host servers 1241 occurs with mutual agreement, soon as the creative works 1233 are loaded and billing agreement/payment are completed. The creative work protection server 1251 compares with web content only once, thereafter periodic comparisons occur only between new or changed works, and reports are generated on this basis and reported back periodically. The creative work protection server 1251, in addition to reporting similarities back to the registered owners, also performs additional tasks such as reporting to the major third party host servers 1241 regarding the possibility of copyright violations and also taking some actions such as assisting to delete the web content, upon consideration, that violate copyright laws.

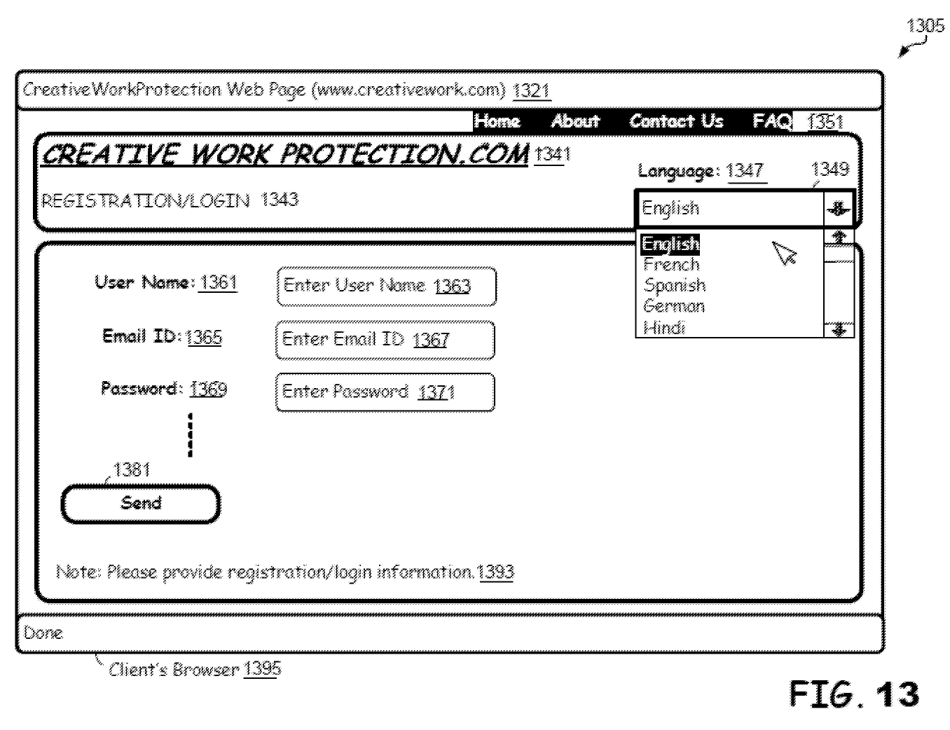

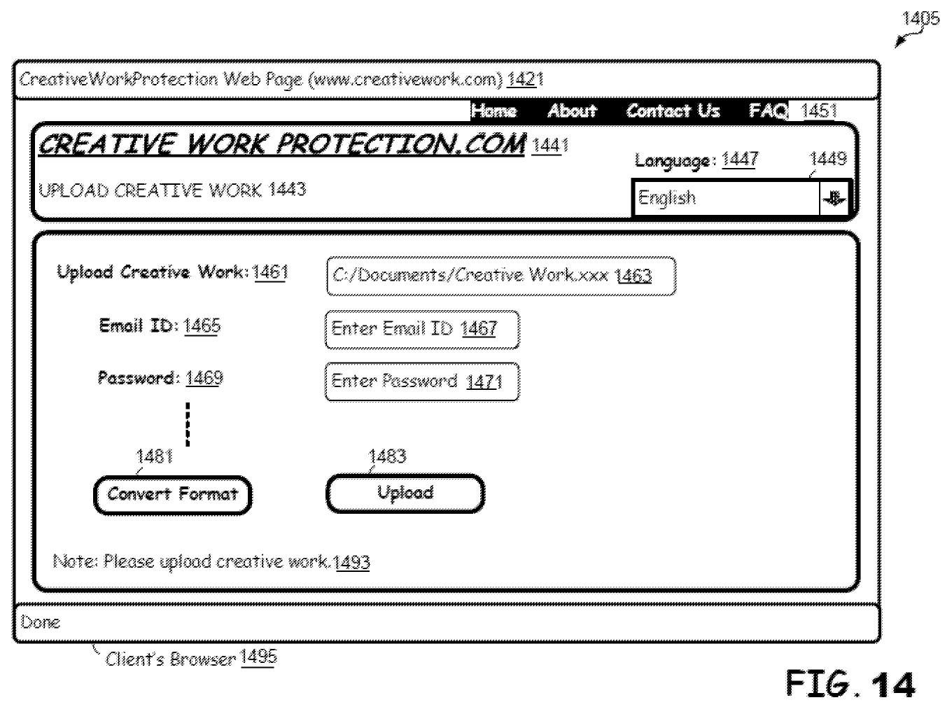

The creative work protection server 1251 provides web page interfaces (refer to the FIG. 13 for an exemplary snapshot of registration/login webpage interface) to the owners of creative works 1233 that allow them to provide some personal information that may include user name, password, date of birth, address, email address, etc. Once registered, the owners of creative works 1233 are provided with web interfaces (refer to the FIG. 14 for an exemplary snapshot of upload webpage interface) to login any time of their choice and upload their creative works (the creative works may contain one or more of textual content, images, audio and/or video recordings) 1233 via web browser 1231 to the creative work protection server 1251. The creative work files containing textual content and images may be any of the standard text, image formats such as Microsoft Word format, Abode Reader format, ‘.jpeg’ format, and ‘.bmp’ format. In case of audio and video recordings, the creative work files may be any of standard audio or video formats such as MP3, WMA, WAV, OGG, AVI, MPEG-1, MPEG-2, and WMV. In case of creative works containing texts and images, the creative work protection server 1251 stores these files in a database and converts them to a suitable format by separating texts and images before further processing. In case of creative works containing audio and/or video recordings, the creative work protection server 1251 stores these files in another database and converts them to a suitable format by: (i) In case of audio, to a predetermined audio format such as WAV; and (ii) In case of video, by separating audio and video portions and then converting them to a predetermined audio and video formats such as WAV and MPEG-2 respectively.

Once the creative works 1233 are uploaded, the creative work protection server 1251 initiates a billing process based upon certain criteria. The billing may occur at the time of uploading or periodically. For example, for creative works with textual content and/or images, the billing may be based upon a fixed price/creative work 1233, fixed price/number of characters in textual content of the creative work 1233, fixed price/image size/image of the creative work 1233, fixed price/report generated for a predetermined period such as a week or month, etc. For creative works containing audio and video recordings, the billing may be based upon a fixed price/creative audio work, fixed price/creative video work, fixed price/minute of the creative audio-video work, fixed price/report generated for a predetermined period such as a week or month, etc.

After the creative works 1233 are acquired and stored and the billing process/agreement are completed, the creative work protection server 1251 begins processing creative works 1233 containing textual content and/or images by segregating textual content and images and then converting them to a standard predetermined format and again storing them. Then, the processing by the creative work protection server 1251 continues, by accessing the web content in the major third party host servers 1241 and database content in the creative work protection server 1251 containing textual content and/or images, storing them temporarily in a database. Then the creative work protection server 1251 separates them into textual content and images and converts these to the same predetermined format. Then, the creative work protection server 1251 compares the textual content of converted creative work with that of converted web content and database content and generates a report if similarities are identified. These reports are stored in a database. Also, for an additional fee, the creative work protection server 1251 reports the similarities to the major third party host servers 1241 via some arrangement with these major third party host servers 1241 and automatically assists in deleting the web content.

Similarly, in case of creative works containing audio and/or video recordings, the processing by the creative work protection server 1251 continues by accessing the web audio or video content or file attachments in the major third party host servers 1241 and database content of the creative work protection server 1251, storing them temporarily in a database. Then the creative work protection server 1251, in case of audio recordings, converts them to the same predetermined format that was used in case of creative work 1233 containing audio recordings. In case of video recordings, the creative work protection server 1251 separates audio and video portions, converts them to the same predetermined formats that were used in case of creative work 1233 containing video recordings. Then, the creative work protection server 1251 compares the audio or video content of converted creative work with that of converted web audio and video content and database content, and generates a report if similarities are identified. These reports are stored in a database. Also, for an additional fee, the creative work protection server 1251 reports the similarities to the major thirds party host servers 1241 and automatically or by consideration assists in deleting the web content. Alternatively, the creative work protection server 1251 may also provide provisions for fees for each upload and download of the web content available in major third party host servers 1241.

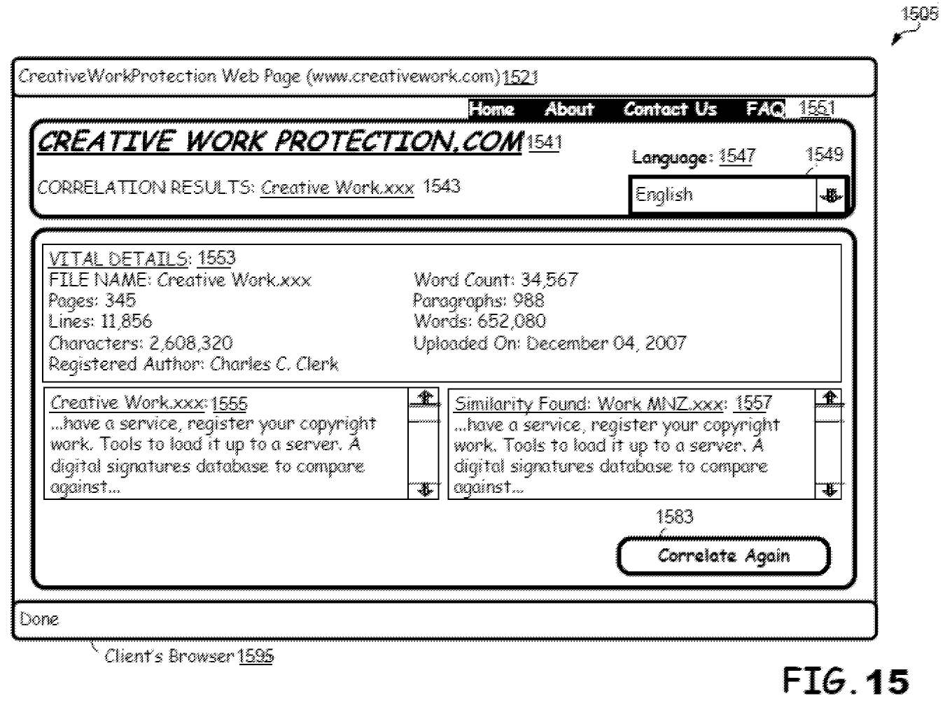

In case of creative works 1233 containing textual content, the comparison between the textual content of converted creative work and that of converted web content and database content occur in one of many possible ways. The first among them is comparison of keywords or phrases (partially determined by the registered owner of the creative work 1233) between the two textual content. This may be specifically applicable if the keywords or phrases are registered or copyrighted. Any matches would be considered as containing similarities. The second among these identifies number of words or number of sentences that contain similarities between these two textual contents by comparing character by character. The similarities are considered to be identified if the number of adjacent characters match beyond a correlation threshold. The correlation threshold may be, for example, 20 adjacent characters or 20 adjacent words. Once this correlation threshold is exceeded, the creative work protection server 1251 continues to compare until all of the similarities are identified and then generates a report on this basis (refer to the FIG. 15 for an exemplary snapshot of report). Other methods of comparison are also contemplated.

In case of creative works 1233 containing images, the correlation between the image content of converted creative work and that of converted web content and database content occur on the basis of pixel by pixel comparison. The converted images are resized to a predetermined standard size and then are compared pixel by pixel for identifications of similarities. A correlation threshold may determine that a similarity is identified. Once this correlation threshold is exceeded (which might be number of adjacent pixels), for example, the creative work protection server 1251 continues to compare until all of the similarities are identified and then generates a report on this basis. Other methods of comparison are also contemplated.

In case of creative works 1233 containing audio recordings, the comparison occurs in one of many possible ways. The first among them is bit by bit comparison. The similarities are considered to be identified if the number of adjacent bits match beyond a correlation threshold. The correlation threshold may be, for example, 256 adjacent bits. Once this correlation threshold is exceeded, the creative work protection server 1251 continues to compare until all of the similarities are identified and then generates a report on this basis. Alternatively, to identify those web audio content having similarities, that are manipulated in some way (such as recording using a microphone), the creative work protection server 1251 may resort to converting the recordings to analog forms and then comparing them. Other methods of comparison are also contemplated.

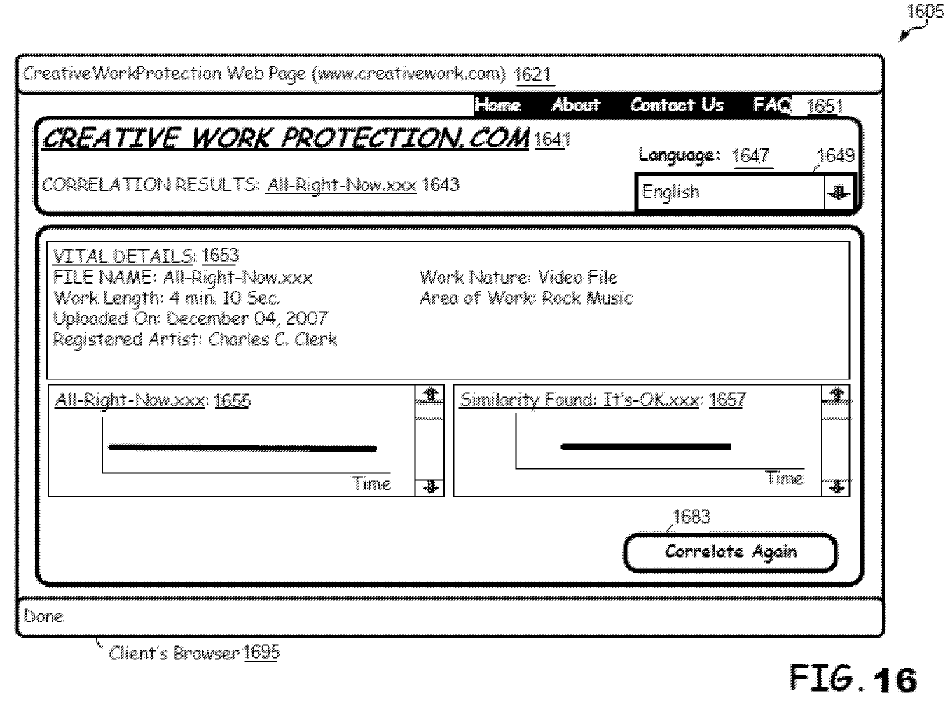

In case of creative works 1233 containing video recordings, the digital signatures are identified and compared as a first step. As a next step, the comparison of audio portion of the video recording is performed, which occurs in a similar fashion as the comparison that occurs in case of audio recordings mentioned before. If no similarities are found, the video portion of the recording may be compared. This occurs on the basis of frame by frame comparison. The similarities are considered to be identified if the number of adjacent frames match beyond a correlation threshold. The correlation threshold may be, for example, 256 adjacent frames. Once this correlation threshold is exceeded, the creative work protection server 1251 continues to compare until all of the similarities are identified and then generates a report on this basis. Other methods of comparison are also contemplated. The reports may be presented in case of both audio and video recordings, in a graphical manner (refer to the FIG. 16 for an exemplary snapshot of report).

The creative work protection server 1251 contains plurality of modules to enable the functionalities mentioned in the above paragraphs. The creative work protection server 1251 contains creative work registration module 1253 and creative work upload/billing module 1255 to perform functions of registration, logging in and billing. The creative work protection server 1251 also contains two major modules, viz., creative text-image work protection module 1261, and creative audio-video work protection module 1281. The creative text-image work protection module 1261 contains creative text-image work correlation module 1263 which performs textual content and image comparisons, creative text-image work correlation result generation module 1265 which generates reports, creative text-image work correlation result dispatch module 1267 which delivers reports to the registered owners and/or major third party host servers 1241 and text-image file format conversion module 1269. The creative text-image work protection module 1261 also contains few databases to store data such as registration information and uploaded creative text-image works. The creative text-image work protection module 1261 contains creative text-image work registration database 1271 and creative text-image work database 1273.

The creative audio-video work protection module 1281 contains creative audio-video work correlation module 1283 which performs audio and video comparisons, creative audio-video work correlation result generation module 1285 which generates reports, creative audio-video work correlation result dispatch module 1287 which delivers reports to the registered owners and/or major third party host servers 1241 and audio-video file format conversion module 1289. The creative audio-video work protection module 1281 also contains creative audio-video work registration database 1291 and creative audio-video work database 1293.

For example, an author of a copyrighted material (that contains several pages of written text and few images or diagrams), may want to protect his/her work being downloaded from major third party host servers 1241. Therefore, the author decides to register with the service of the creative work protection server 1251. After registration, the author may upload electronic version of his/her work in a standard file format and fulfill the billing obligations.

Then, the creative work protection server 1251 stores this file, segregates textual content from images or diagrams. The creative work protection server 1251 then converts these textual content and images or diagrams to a predetermined format. For example, the textual content may be converted to ‘.txt’ format while the diagrams or images may be converted to ‘.jpg’ format. Then, the creative work protection server 1251 begins to acquire the web content and database content and begins the comparison process. If no similarities are found, then no reports are generated and the process temporarily ends there. On the contrary, if similarities are detected, then the creative work protection server 1251 generates report that may contain major third party host server 1241 details, vectors associated with the web content as well as the areas of similarity in textual content and images and stores them in a database. Then, the accumulated reports over a predetermined period of time such as a day, week or month are formatted in a readable manner and submitted to the viewing of the author. The reports may be sent via email to the author, or may be made available on a webpage upon logging into the creative work protection server 1251. If requests are made by the author for additional services such as sending reports to the major third party host server 1241, then the reports are generated and sent to the major third party host server 1241 for further consideration.

In another example, an artist of a copyrighted rock music video, may want to prevent his/her work being downloaded (or played) from the major third party host servers 1241 without permission. Therefore, the artist may decide to register with the creative work protection service of the creative work protection server 1251. After registration, the artist may upload, for example, a MPEG-2 format video recording of the rock music and fulfill the billing obligations. Alternatively, the creative work protection server 1251 also allows the artist to upload the rock music video in many possible formats.

Then, the creative work protection server 1251 stores the rock music video file. Then, the creative work protection server 1251 converts the audio and video potions of the video recording to predetermined formats. Then, the creative work protection server 1251 begins to acquire the video content from the major third party host servers 1241 and database video content of the creative work protection server 1251 and begins the comparison process. If no similarities are found, then no reports are generated and the process temporarily ends there. On the contrary, if similarities are detected, then the creative work protection server 1251 generates report that may contain major third party host server 1241 details, vectors associated with the video content as well as the areas of similarity in the rock music video and stores them in a database. Then, the accumulated reports over a predetermined period of time such as a day, week or month are formatted in a readable manner and submitted to the viewing of the artist, either via email or via webpage interface upon logging into the creative work protection server 1251.

FIG. 13 is an exemplary schematic block diagram illustrating snap shot of an example registration/login page that assists owners of creative works to register or login to the creative work protection server of FIG. 12. Specifically, the exemplary snap shot illustrated shows a creative work registration/login page 1305 delivered to a client's browser 1395 of client device, that allow owners of creative works to register and login by providing some personal information that may include user name, password, date of birth, address, email address, etc. The creative work registration/login page 1305 delivered may contain a page title such as ‘CreativeWorkProtection Web Page (www.creative.work.com)’ 1321. It may also contain a title such as ‘CREATIVE WORK PROTECTION.COM’ 1341 and a tool bar 1351 providing access to other pages of the creative work protection server. A language 1347 selection tool 1349 may also be provided, that allows user to choose a language in these pages. A sub-title that briefly explains the page content such as ‘REGISTRATION/LOGIN’ 1343 may also be provided.

One of the windows in the creative work registration/login page 1305 may request the owners of creative works for details such as user name 1361, email ID 1365, password 1369 etc. by providing text boxes 1363, 1367 and 1371. A ‘Send’ 1381 button allows the owners of creative works to complete the registration formalities. Once registered, the owners may login any time of their choice and upload their creative works and view the results of comparisons. A helpful text such as ‘Note: Please provide registration/login information’ 1393 may also be provided.

FIG. 14 is an exemplary schematic block diagram illustrating snap shot of an upload page that assists owners of creative works to upload their works to the creative work protection server of FIG. 12. In specific, the exemplary snap shot illustrated shows a creative work upload page 1405 delivered to a client's browser 1495 of client device, that allow owners of creative works to upload, after logging into the creative work protection server. The creative work upload page 1405 delivered may contain a page title such as ‘CreativeWorkProtection Web Page (www.creativework.com)’ 1421. It may also contain a title such as ‘CREATIVE WORK PROTECTION.COM’ 1441 and a tool bar 1451 providing access to other pages of the creative work protection server. A language 1447 selection tool 1449 may also be provided, that allows user to choose a language in these pages. A sub-title that briefly explains the page content such as ‘UPLOAD CREATIVE WORK’ 1443 may also be provided.

One of the windows in the creative work upload page 1405 may request the owners of creative works for login details such as email ID 1465, password 1469 and by providing text boxes 1467 and 1471. Alternatively, login webpage may be provided separately from that of creative work upload page 1405. In addition, an upload creative work 1461 title followed by a text box 1463 that allows the registered owners to enter address of the creative work. The creative work upload page 1405 may also provide browsing facilities that allow registered owners to browse through the personal computer and open the file to be uploaded automatically. A ‘Convert Format’ 1481 button allows registered owners to convert format of the creative work document to any other formats (this is optional). An ‘Upload’ 1483 button allows the owners of creative works to send the creative work document to the creative work protection server. A helpful text such as ‘Note: Please upload creative work’ 1493 may also be provided.

FIG. 15 is an exemplary schematic block diagram illustrating snap shot of a result page containing vital details of the creative work containing text and report of similarities in the respective content of database of the creative work protection server and of the major third party host servers of FIG. 12. Specifically, the exemplary snap shot illustrated shows a creative text work correlation (comparison) results page 1505 delivered to a client's browser 1595 of client device, containing vital statistics of the creative text work and selected portions of texts that are similar. The creative text work correlation results page 1505 delivered may contain a page title such as ‘CreativeWorkProtection Web Page (www.creativework.com)’ 1521. It may also contain a title such as ‘CREATIVE WORK PROTECTION.COM’ 1541 and a tool bar 1551 providing access to other pages of the creative work protection server. A language 1547 selection tool 1549 may also be provided, that allows user to choose a language in the result pages. A sub-title that provides the name of the creative text work in consideration such as ‘CORRELATION RESULTS: Creative Work.xxx’ 1543 may also be provided.

One of the windows in the creative text work correlation results page 1505 may provide vital statistics of the creative text work in consideration such as ‘VITAL DETAILS:’ 1553 followed by details such as file name, word count, number of pages, number of paragraphs, number of lines, number of words, number of characters, uploaded on and registered author. Additional vital statistics related to the web text content, file attachments or other creative works in the database of creative work protection server in which the similarity is found such as web site, web page/file attachment link, web page/file statistics and the locations within the web page/file where similarity is found may also be provided in this window (not shown).

A second window illustrated provides the file name of the creative text work of a registered owner such as ‘Creative Work.xxx:’ 1555 followed by the text where similarities are found. A third window illustrated provides the file name of the web text content posted by a third party server or database text content such as ‘Similarity Found: Work MNZ.xxx:’ 1557 followed by the text that contains the similarities. The author may be able to decide whether to ignore the similarity found or to take any necessary actions. Also, a ‘Correlate Again’ button 1583 provides options to the author to continue to the next similarity either within the current web page/file text content or in another web page/file.

FIG. 16 is an exemplary schematic block diagram illustrating snap shot of a result page containing vital details of the creative work containing video content and report of similarities in the respective content of database of the creative work protection server and of the major third party host servers of FIG. 12. In specific, the exemplary snap shot illustrated shows a creative video work correlation (comparison) results page 1605 delivered to a client's browser 1695 of client device, containing vital statistics of the creative video work and graphical representation of areas of similarity. The creative video work correlation results page 1605 delivered may contain a page title such as ‘CreativeWorkProtection Web Page (www.creativework.com)’ 1621. It may also contain a title such as ‘CREATIVE WORK PROTECTION.COM’ 1641 and a tool bar 1651 providing access to other pages of the creative work protection server. A language 1647 selection tool 1649 may also be provided, that allows user to choose a language in the result pages. A sub-title that provides the name of the creative video work in consideration such as ‘CORRELATION RESULTS: All-Right-Now.xxx’ 1643 may also be provided.

A first window in the creative video work correlation results page 1605 may provide vital statistics of the creative video work in consideration such as ‘VITAL DETAILS:’ 1653 followed by details such as file name, work nature, work length, area of work, uploaded on and registered artist. Additional vital statistics related to the web video content, file attachments or database content in which the similarity is found such as web site, web video content/file attachment link, web video content/file statistics and the locations within the web video content/file where similarity is found may also be provided in this window (not shown).

A second window illustrated provides the file name of the creative video work of a registered owner such as ‘All-Right-Now.xxx:’ 1655 followed by some graphical representation of the length of the creative video work. A third window illustrated provides the file name of the web video content/file attachment posted by a third party server such as ‘Similarity Found: It's-OK.xxx:’ 1657 followed by a graphical representation similar to that of the second window depicting the areas where similarity found. The artist is able to take necessary actions based upon observation of displayed similarities. Also, a ‘Correlate Again’ button 1683 provides options to the artist to continue to the next similarity in another web video content/file.

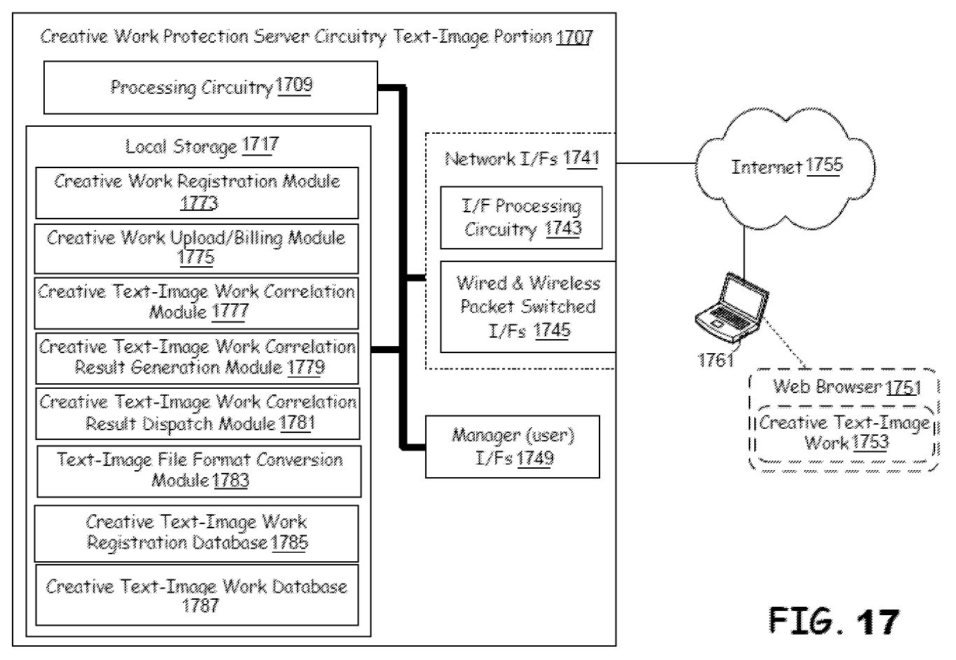

FIG. 17 is a schematic block diagram illustrating components of the creative work protection server constructed in accordance with the embodiment of FIG. 12 of the present invention. The creative work protection server circuitry text-image portion 1707 may in part or full be incorporated into any computing device that operates as an Internet based server. The creative work protection server circuitry text-image portion 1707 generally includes processing circuitry 1709, local storage 1717, manager interfaces 1749, and network interfaces 1741. These 10 components communicatively coupled to one another via one or more of a system bus, dedicated communication pathways, or other direct or indirect communication pathways. The processing circuitry 1709 may be, in various embodiments, a microprocessor, a digital signal processor, a state machine, an application specific integrated circuit, a field programming gate array, or other processing circuitry.

Local storage 1717 may be random access memory, read-only memory, flash memory, a disk drive, an optical drive, or another type of memory that is operable to store computer instructions and data. The local storage 1717 includes creative work registration module 1773 and creative work upload/billing module 1775 to perform functions of registration, logging in and billing. In addition, the local storage 1717 includes creative text-image work correlation module 1777 which performs textual content and image comparisons, creative text-image work correlation result generation module 1779 which generates reports, creative text-image work correlation result dispatch module 1781 which delivers reports to the registered owners and/or host third party server (not shown) and that of creative text-image work database 1787, and text-image file format conversion module 1783. The local storage 1717 also contains creative text-image work registration database 1785 to store registration, logging in and billing information of the registered owners and the creative text-image work database 1787 to store creative text-image work 1753 of registered owners.

The network interfaces 1741 contain wired and wireless packet switched interfaces 1745 and may also contain built-in or an independent interface processing circuitry 1743. The network interfaces 1741 allow the creative work protection server circuitry text-image portion 1707 to communicate with client devices such as 1761 and to upload creative text-image works 1753 via a web browser 1751 and to deliver results. The manager interfaces 1749 may include a display and keypad interfaces. These manager interfaces 1749 allow the user at the creative work protection server circuitry text-image portion 1707 to control aspects of the present invention. The client device 1761 illustrated are communicatively coupled to the creative work protection server circuitry text-image portion 1707 via an Internet 1755.

In other embodiments, the creative work protection server circuitry text-image portion 1707 of the present invention may include fewer or more components than are illustrated as well as lesser or further functionality. In other words, the illustrated creative work protection server circuitry text-image portion is meant to merely offer one example of possible functionality and construction in accordance with the present invention.

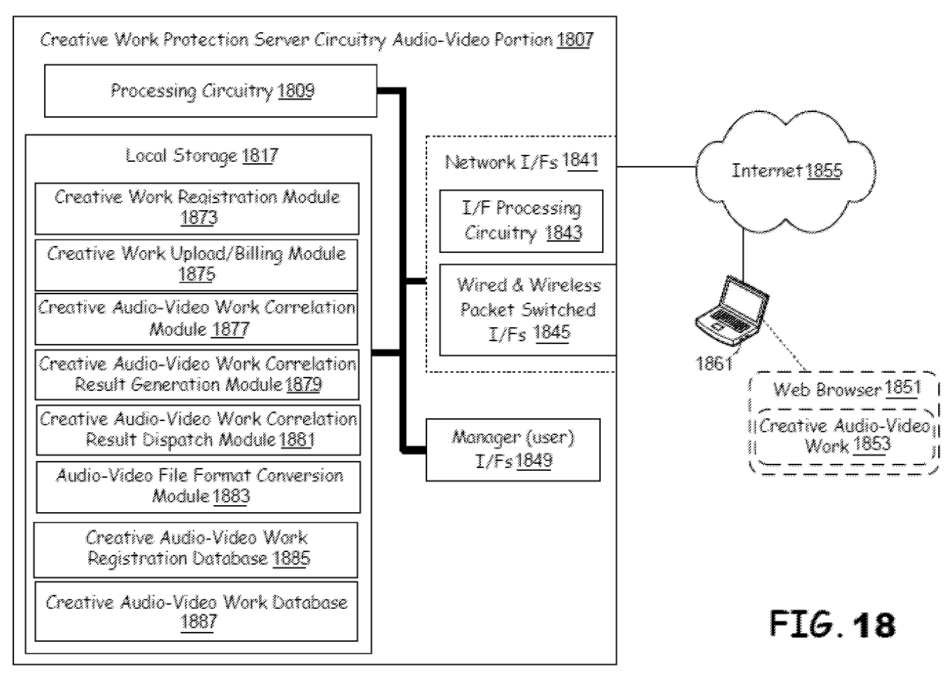

FIG. 18 is a schematic block diagram illustrating components of the creative work protection server constructed in accordance with the embodiment of FIG. 12, in continuation of FIG. 17. The creative work protection server circuitry audio-video portion 1807 may in part or full be incorporated into any computing device that operates as an Internet based server. The creative work protection server circuitry audio-video portion 1807 generally includes processing circuitry 1809 (1709 of FIG. 17), local storage 1817 (1717 of FIG. 17), manager interfaces 1849 (1749 of FIG. 17) and network interfaces 1841 (1741 of FIG. 17). These components communicatively coupled to one another via one or more of a system bus, dedicated communication pathways, or other direct or indirect communication pathways. The processing circuitry 1809 may be, in various embodiments, a microprocessor, a digital signal processor, a state machine, an application specific integrated circuit, a field programming gate array, or other processing circuitry.

Local storage 1817 may be random access memory, read-only memory, flash memory, a disk drive, an optical drive, or another type of memory that is operable to store computer instructions and data. The local storage 1817 includes creative work registration module 1873 (1773 of FIG. 17) and creative work upload/billing module 1875 (1775 of FIG. 17) to perform functions of registration, logging in and billing. In addition, the local storage 1817 includes creative audio-video work correlation module 1877 which performs audio and video content comparisons between creative audio-video work 1853 of registered owners and audio-video content of third party servers (not shown) and that of creative audio-video work database 1887, creative audio-video work correlation result generation module 1879 which generates reports, creative audio-video work correlation result dispatch module 1881 which delivers reports to the registered owners and/or host third party server and audio-video file format conversion module 1883. The local storage 1817 also contains creative audio-video work registration database 1885 to store registration, logging in and billing information of the registered owners and the creative audio-video work database 1887 to store creative audio-video work 1853 of the registered owners.

The network interfaces 1841 contain wired and wireless packet switched interfaces 1845 and may also contain built-in or an independent interface processing circuitry 1843. The network interfaces 1841 allow the creative work protection server circuitry audio-video portion 1807 to communicate with client devices such as 1861 and to upload creative audio-video works 1853 via a browser 1851 and to deliver results. The manager interfaces 1849 may include a display and keypad interfaces. These manager interfaces 1849 allow the user at the creative work protection server circuitry audio-video portion 1807 to control aspects of the present invention. The client device 1861 illustrated are communicatively coupled to the creative work protection server circuitry audio-video portion 1807 via an Internet 1855.

In other embodiments, the creative work protection server circuitry audio-video portion 1807 of the present invention may include fewer or more components than are illustrated as well as lesser or further functionality. In other words, the illustrated creative work protection server circuitry audio-video portion is meant to merely offer one example of possible functionality and construction in accordance with the present invention.

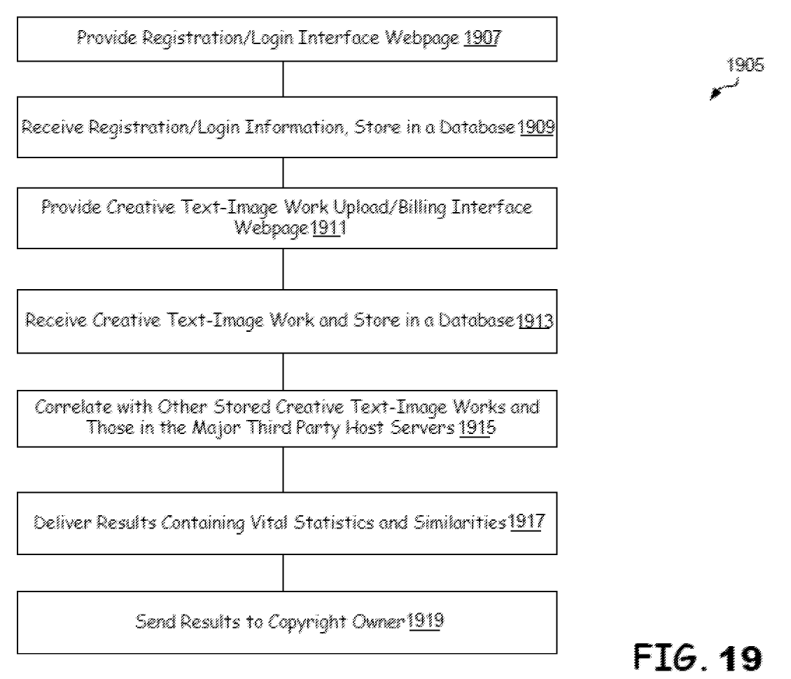

FIG. 19 is a flow diagram illustrating functionality 1905 of the creative work protection server of FIG. 12, wherein the creative work protection server identifies and reports similarity in creative works containing textual content and images. The functionality of the creative work protection server that deals with creative text-image works begins at a block 1907 when an owner of the creative text-image work is provided with registration/login interface webpage. At a next block 1909, the creative work protection server that deals with creative text-image works receives registration information if the owner is interacting with the creative work protection server for the first time and stores this information in a database. In subsequent interactions, the creative work protection server verifies login information and allows the owner to access services of the creative work protection server. The registration information may contain user name, password, date of birth, address, email address and other relevant information.

At a next block 1911, the creative work protection server provides creative text-image work upload/billing interface. The owner may upload any number of creative text-image works in subsequent visits (after initial registration), and the billing may occur on one of many possible ways. This includes a fixed price/creative text-image work, fixed price/number of characters in textual content of the creative text-image work, fixed price/image size/image of the creative text-image work, fixed price/report generated for a predetermined period such as a week or month, etc. That is, the billing may occur immediately after uploading of creative text-image works or may occur periodically based upon an agreement with the registered owner. And the service may be provided for a fixed period of time such as one year or two years depending upon agreement with the registered owner.

At a next block 1913, the creative work protection server receives creative text-image works and stores them in a database. At a next block 1915, the creative work protection server correlates the creative text-image work with that of web content in major third party host servers and creative text-image content of the database of creative work protection server. Then, creative work protection server generates a report containing all of the website links (together with vectors of web pages or files contained in the web sites) and titles of the database text-image content that contain texts or images having similarities with that of content of creative text-image works. At a next block 1917, the creative work protection server delivers results containing vital statistics of the creative text-image works, along with similarities found. In a final block 1919, the creative work protection server sends results to the registered owner, and upon agreement with registered owner and major third party host servers, to the major third party host servers.

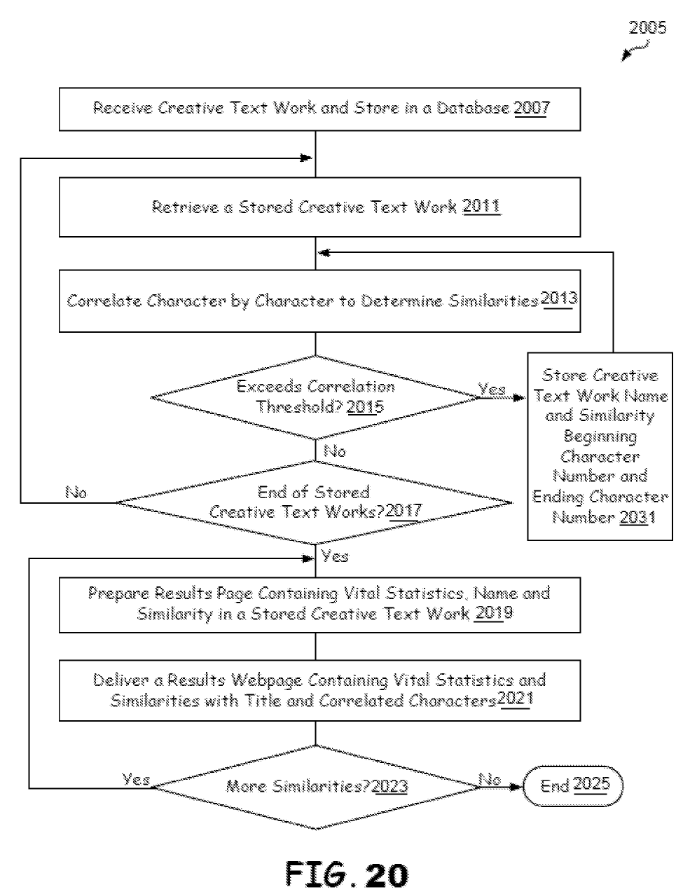

FIG. 20 is a flow diagram illustrating functionality 2005 of the creative work protection server of FIG. 12 in detail, with the creative work containing texts in consideration. The detailed functionality concerning the creative work containing texts of a registered owner begins at a block 2007, when the creative work protection server receives creative text works and stores them in a database. To make this possible, the creative work protection server provides webpage interfaces to the registered owner to upload one or more creative text works.

At a next block 2011, the creative work protection server retrieves stored creative text work. At a next block 2013, the creative work protection server correlates character by character with that of web text content in major third party host servers and that in the database of the creative work protection server to determine similarities. At a next decision block 2015, the creative work protection server determines if the similarities exceed a predetermined correlation threshold. If yes, then the creative work protection server stores creative text work name along with web page details or titles in the database and similarity beginning character number and ending character number, at a next block 2031. Then, the processes of blocks 2013 and 2015 are repeated. If not at the decision block 2015, at a next decision block 2017, the creative work protection server determines if all of the creative text works of the registered owner are compared. If not, with a next creative text work, the processes of blocks 2011, 2013, 2015 and 2031 are repeated. In another embodiment, the comparison may occur on the basis of keywords, which is not shown in the flowchart.

If yes at the decision block 2017, then the creative work protection server prepares a result page (from the stored information of similarities) containing vital statistics, name and web links of the text that contains similarities along with additional information, at a next block 2019. Then, at a next block 2021, the creative work protection server delivers the result page containing vital statistics and similarities with title and correlated characters. At a next decision block 2023, the creative work protection server determines if more similarities within the same webpage or in another webpage (that belongs to the creative text works of the registered owner) or in the database files are found. If yes, then the processes of blocks 2019 and 2021 are repeated to generate addition result pages. If not, at a final block 2025, the functionality ends.

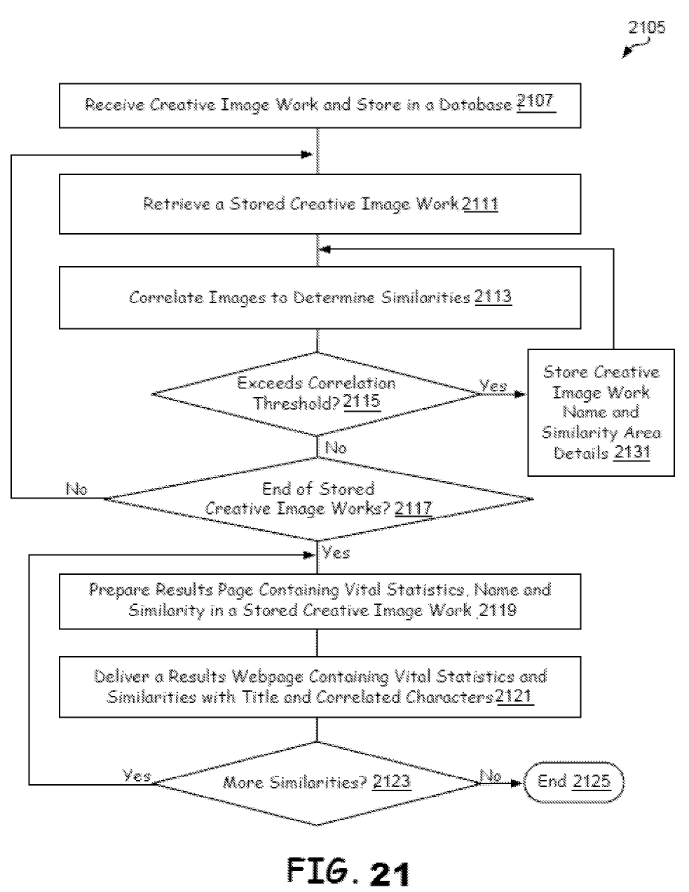

FIG. 21 is a flow diagram illustrating functionality 2105 of the creative work protection server of FIG. 12 in detail, with the creative work containing images in consideration. The detailed functionality concerning the creative work containing images begins at a block 2107, when the creative work protection server receives creative image works and stores them in a database. The creative work protection server provides webpage interfaces to registered owner of the creative image works to upload one or more creative image works.

At a next block 2111, the creative work protection server retrieves stored creative image work. At a next block 2113, the creative work protection server correlates images pixel by pixel (after converting formats to a predetermined image format and resizing the images) with that of web image content in major third party host servers and that in the database of creative work protection server to determine similarities. At a next decision block 2115, the creative work protection server determines if the similarities exceed a predetermined correlation threshold. If yes, then the creative work protection server stores creative image work name along with web page details and similarity area details, at a next block 2131. Then, the processes of blocks 2113 and 2115 are repeated. If not at the decision block 2115, at a next decision block 2117, the creative work protection server determines if all of the creative image works of the registered owner are compared. If not, with a next creative image work, the processes of blocks 2111, 2113, 2115 and 2131 are repeated.

If yes at the decision block 2117, then the creative work protection server prepares a result page (from the stored information of similarities) containing vital statistics, name and web links of the image that contains similarities along with additional information, at a next block 2119. Then, at a next block 2121, the creative work protection server delivers the result page containing vital statistics and similarities with title and correlated image areas. At a next decision block 2123, the creative work protection server determines if more similarities within the same webpage image or in another webpage image or images in the database are found. If yes, then the processes of blocks 2119 and 2121 are repeated to generate addition result pages. If not, at a final block 2125, the functionality ends.

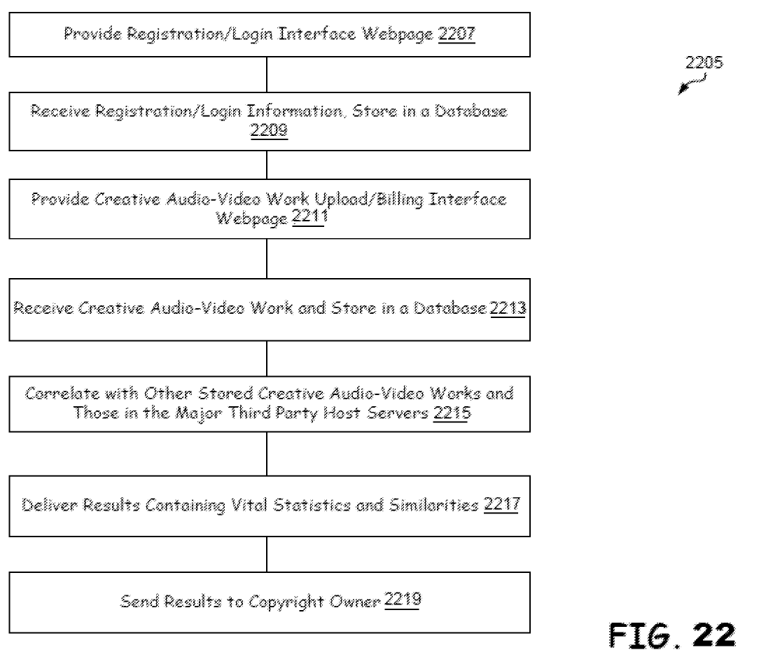

FIG. 22 is a flow diagram illustrating functionality 2205 of the creative work protection server of FIG. 12 in detail, wherein the creative work protection server identifies and reports similarity in creative works containing audio and video content. The functionality of the creative work protection server that deals with audio-video creative work content begins at a block 2207 when an owner of a creative audio-video work is provided with registration/login interface webpage. At a next block 2209, the creative work protection server receives registration information (for the first time) and stores this information in a database. In subsequent interactions, the creative work protection server verifies login information and allows the owner to access services of the creative work protection server. The registration information may contain user name, password, date of birth, address, email address and other relevant information.

At a next block 2211, the creative work protection server provides creative audio-video work upload/billing webpage interface. The owner may upload any number of creative audio-video works in subsequent visits (after initial registration), and the billing may occur on one of many possible ways. This includes a fixed price/creative audio-video work, fixed price/second of the creative audio-video work, fixed price/report generated for a predetermined period such as a week or month, etc. That is, the billing may occur immediately after uploading of creative audio-video works or may occur periodically based upon an agreement with the registered owner. The service may be provided for a fixed period of time such as one year or two years depending upon agreement with the registered owner.

At a next block 2213, the creative work protection server receives creative audio-video works and stores them in a database. At a next block 2215, the creative work protection server correlates the creative audio-video work with that of web content in the major third party host servers and that in the database of creative work protection server. Then, creative work protection server generates a report containing all of the titles and website links that contain audio-video content having similarities with that of content of creative audio-video works. At a next block 2217, the creative work protection server delivers results containing vital statistics of the creative audio-video works, along with similarities found. In a final block 2219, the creative work protection server sends results to the registered owner, and upon agreement with registered owner and host third party servers, to the major third party host servers.

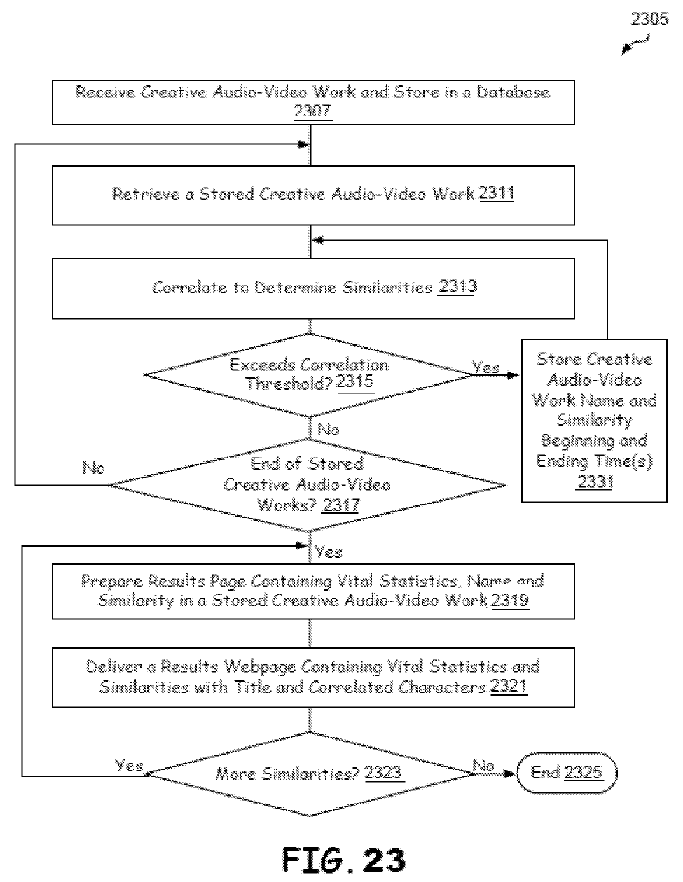

FIG. 23 is a flow diagram illustrating functionality 2305 of the creative work protection server of FIG. 12 in detail, with the creative work containing audio-video content in consideration. The detailed functionality concerning creative audio-video works begins at a block 2307, when the creative work protection server receives creative audio-video works and stores them in a database. The creative work protection server provides webpage interfaces to registered owner of the creative audio-video works to upload one or more creative audio-video works.

At a next block 2311, the creative work protection server retrieves stored creative audio-video work. At a next block 2313, the creative work protection server correlates audio-video works with that of web audio-video content in major third party host servers and that in the database of creative work protection server to determine similarities. In case of audio recordings, bit by bit comparison may be employed. Alternatively, in some cases, the creative work protection server may resort to converting the recordings to analog forms and then comparing them. In case of video recordings, the digital signatures are identified and compared as a first step. As a next step, the comparison of audio portion of the video recording is performed and then, if no similarities are found, the video portion of the recording are compared. The video portion comparison may occur on the basis of frame by frame comparison. Other methods of comparison are also contemplated.

At a next decision block 2315, the creative work protection server determines if the similarities exceed a predetermined correlation threshold. In case of audio recordings, the correlation threshold may be a predetermined number of adjacent bits and in case of video this may be a predetermined number of adjacent frames. If yes at the decision block 2315, then the creative work protection server stores creative audio-video work name, vectors for web audio-video content and the database content along with similarity beginning and ending times, at a next block 2331. Then, the processes of blocks 2313 and 2315 are repeated. If not at the decision block 2315, at a next decision block 2317, the creative work protection server determines if all of the creative audio-video works of the registered owner are correlated. If not, with a next creative audio-video work, the processes of blocks 2311, 2313, 2315 and 2331 are repeated.

If yes at the decision block 2317, then the creative work protection server prepares a result page (from the stored information of similarities) containing vital statistics, name and web links of the audio-video content that contains similarities along with additional information, at a next block 2319. Then, at a next block 2321, the creative work protection server delivers the result page containing vital statistics and similarities with title and correlated audio-video times. At a next decision block 2323, the creative work protection server determines if more similarities within the same audio-video content or in another audio-video content are found. If yes, then the processes of blocks 2319 and 2321 are repeated to generate addition result pages. If not, at a final block 2325, the functionality ends.

The discussion will now turn to additional non-limiting example aspects of the present disclosure. A further embodiment of a copyright registration and screening system may be employed to (a) collect and manage copyrighted content, (b) identify authorized and unauthorized postings, (c) account for and manage downloading and access, (d) support communications between a copyright owner and a content consumer (listener/viewer/downloader), and (e) support automated “fair use” assessments. The term “content” as used herein refers to any copyrightable content such as text, images, video, audio, software (source and object code) and so on.

The following example functionality may, for example and without limitation, be performed by any one or more of the previously discussed system components (e.g., individually or collectively in a distributed system).

The copyright registration and screening system may, for example, be implemented as an independent service portal or integrated in whole or in port within either or both of a single content hosting web portal and a web page based search infrastructure. For example, as an independent service portal, all copyright related services may be provided to a plurality of content hosting web sites (e.g., YouTube, Facebook etc.) and a web page based search infrastructure (e.g., Google, Bing, etc.). Such sites and infrastructure may interact with the service portal on a content item by content item basis as a new posting or upload is encountered (e.g., by delivering such content or portions or signatures/watermarks to the service portal from screening). Such sites and infrastructure may also fully integrate with the service portal by directly exposing their database storage to search and comparison algorithms of the service portal. Such service portal functionality may, for example, be dedicated to and within a single content hosting web site or a single web page based search infrastructure as an alternative.

Copyright registration services provided by the copyright registration and screening system may, for example, comprise registration of original copyright material as well as for authorized derivative works (e.g., version control) related thereto. Registration may, for example, comprise collection of all associated information (e.g., full name, address, citizenship, etc.) that is needed to formally register a copyright work with any official agency of any country in the world. With this information, the copyright registration and screening system may automatically or at least automate the formal registration process. This may, for example, be performed by populating all recent forms from any official agency with such information and managing funds collection and application for official agency fees and additional fees for performing the automated service. For example, an owner may indicate a desire for official registration and receive a list of official agencies from which to choose. For those selected, forms are populated and fees are tallied. Upon confirmation from the owner, billing is applied and all forms are either electronically delivered or printed and mailed for the owner to the official agencies for formal registration. Further copyright services may, for example, be supported via the copyright registration and screening system (and associated business entity) or handed off to a copyright law firm or other formal copyright management company.

Copyright content may, for example, be stored in native or compressed formats. Original and derivative work versions may be similarly stored. Compression techniques, if employed, may for example be applied on a content element by element basis. Alternatively, compression may be applied across original and derivative works. For example, derivative work compression might only involve compression of differences between the derivative and the original (or a previous derivative) content. Thereafter, with reference to the original content and using the difference data, the derivative may be reconstructed.

The copyright registration and screening system may, for example, collect original and derivative work content via (a) direct full or partial database content extraction (e.g., from BMI—from Broadcast Music, Inc. databases, etc.), (b) browser or App based upload interfaces, (c) email (which includes treatment of both email content and each attachment), (d) SMS (e.g., short message service), (e) other text, audio, video capture interfaces (e.g., browser or App based, etc.), and (f) snail mail with post receipt conversion to digital formats. Depending on the embodiment and possibly on the type of content, either the full content may be collected or merely excerpts, signatures, watermarks, or any other portion or extract from the full content. With full or portions of registered content stored within the copyright registration and screening system, various comparison and correlation techniques are applied to find matches with any third party hosting or posting (e.g., upload, etc.) content.

Note that the copyright registration and screening system may provide secure, certified time stamping of all collections. Future downloads by the copyright owner or other authorized parties may be guaranteed to receive exactly what was collected (e.g., tamper proof, etc.) along with collection related information (e.g., time stamping, submitter, associated information collected and associated time stamps, etc.). Submitters may, for example, be required to securely log in to the system (e.g., establish a secure link through the Internet, etc.) and provide time stamped user profile information that will be associated with any content or related information/data submissions. In other words, to prevent tampering, the system may maintain strict control of access (e.g., by a single or multiple users, e.g., a single copyright owner or company/roster, etc.), content submission and all associated comments, descriptions, authorship and ownership data.

Having such a secure, tamper proof system will prove beneficial even beyond copyrights. Trade secrets and patent rights may be supported by establishing a time stamped storage location for any of a submitter's ideas or expressions. For example, a painter might take a photo (a derivative work) of a recently completed painting and upload same to support a future authorship claim. Similarly, before discussing important technology in a meeting with a client, an upload of a presentation might be carried out. During the meeting, an audio/video feed may be stream uploaded (or via post meeting batch upload) into the copyright registration and screening system. Years later, to resolve disputes that might arise related to trade secret or copyright ownership, the presentation and the feed may be retrieved and evaluated.

In such circumstances, clients of the copyright registration and screening system might not feel comfortable with their uploads being exposed to the staff of the copyright registration and screening system. To eliminate such concerns, a secure key system may be employed by the client. For example, a (pseudo) random key may be generated and stored on the client side computer system along with the client's own copy of the content and upload information. Before delivery to the copyright registration and screening system, the client side system may apply encryption using the key. Thereafter, encrypted versions of the content and associated information may be uploaded to the copyright registration and screening system. In this way, a hacker or rogue employee will only be able to gain access to unusable, encrypted data.

Whether content is collected to support a copyright, trade secret, invention or other authorship, priority or long term storage concern, the copyright registration and screening system supports unofficial and official downloading and retrieval mechanisms. For example, an official output associated with particular content might involve an automated generation of an affidavit with the content being printed as an attachment thereto. Signatures, stamping and notarization may occur in a partially or fully automated manner. In other words, the copyright registration and screening system supports a copyright owner that may require an official document in a soft-copy or hard-copy form that may be used in a legal, private dispute resolution, or official registration proceeding.

In addition, some submitters may be happy with displaying (read only) and perhaps even disseminating their copyrighted content in its full, native format so long as they maintain control of the process. Other submitters want to restrict access partially to either excerpts of the native format or reduced quality output of all or portions of their content. Yet other submitters desire no access at all except for authorized parties via log in security verification. No matter what their needs or requirements, the copyright registration and screening system addresses same via set up configurations made by a submitter upon submission, account registration, and/or at any time thereafter via reconfiguration. Along with such full or partially restricted access, billing of content consumer/downloaders may also be managed by the copyright registration and screening system as set forth in the configuration. For example, a submitter may select to offer a single image or short excerpt (e.g., trailer or first few minutes) of a video and require a payment before providing a DRM (Digital Rights Management) supported download for presentation to a content consumer (viewer/listener). Such and other types of revenue collection is handled by the copyright registration and screening system.

Funds may be collected from a content consumer/downloader, a first portion of such funds delivered to an account of the content owner, and a second portion of such funds retained for services rendered. Funds may also be collected from the content owner/submitter based on one or more of storage costs (e.g., byte related, etc.), owner/submitter access, uploading and/or downloading events, for each content consumer/downloader access and downloading/viewing/listening events, for advertising fees, etc. Regarding the latter, the copyright registration and screening system may provide a portal service to support pluralities of content consumer/downloaders. If a submitter/owner opts in, their registered content may be advertised via categorized listings and excerpts made available to any browsing authorized or registered content consumer/downloader. A search interface may also be provided to such content consumer/downloaders along with, for example, category filters. Thus, a content consumer/downloader may be seeking for example a music video that happens to be registered. By browsing a category of music, for example with subcategories jazz/video/free, access to free downloadable jazz music videos may be found. Similarly, searching for “Wynton Marsalis” with filters for video may yield a jazz video but with a payment requirement (e.g., to be distributed to the copyright owner and/or retained for services rendered by the copyright registration and screening system). Thus, a content owner may choose whether or not content consumer/downloaders (or a particular group thereof) may gain access to their content, and whether such access will be for free or cost based distribution.

For example, in an example implementation, a central copyright registration and screening (CRS) service that integrates (e.g., fully or via an associated, independent portal service) with a site such as YouTube. After receiving an upload which a user desires to post, YouTube may for example deliver either the upload, watermark, excerpt and/or a digital signature or representation thereof to the CRS which analyses the delivery in view of CRS registration database data to identify full or partial (derivative works) matches. If no matches are found, YouTube is signaled to proceed to post the upload. If a full or partial match is detected, the CRS service may do one or more of several things per copyright owner and YouTube site selection such as, for example: (i) cause YouTube to reject the posting (along with delivering a related message to the uploading user which will allow the uploader to trigger a dispute resolution); (ii) send an (email) indication of the upload and posting attempt plus at least some related info to the copyright owner; (iii) cause YouTube to allow posting but with restrictions (e.g., excerpts and/or reduced quality and/or vectors to authorized postings); (iv) cause YouTube or itself managing a funds collection (or cause funds collection set up) wherein funds may be collected from the uploading user and/or future downloading others to satisfy the copyright owner and compensate the CRS service; (v) set up a mechanism through which the uploading user and the copyright owner may interact and/or negotiate an upload arrangement (directly or indirectly and with or without bi-directional, staged anonymity); etc.

The CRS service may also, for example, be integrated (in whole or in part) into the search infrastructure of companies such as Google. Therein, while building its web content database, a search infrastructure post may deliver new content collected from hosting servers and forward same to the CRS service. Upon receiving clearance, the search infrastructure may integrate the content to its functional database (e.g., either by adding or releasing same into service, for example via a tag/field). Without clearance, such content might not be accessible to future search inquiries. In an example case in which there is no clearance to host, the CRS service and/or the search infrastructure may communicate same to the system administrators of the underlying servers and/web hosting service. Once made aware, such services may for example either block the hosting or agree to a revenue collection approach involving distribution of funds to the original content copyright owner and possibly to the CRS service for any support rendered in future download/viewing funds collection.

Various marketing approaches might be used to draw copyright owners to the CRS service. Beyond word of mouth and traditional service advertising placements, the CRS service may employ its services for an unregistered copyright owner and then automatically generate an advertisement tailored for such owner that reveals such service performance details. For example, the CRS service may automatically make unregistered entries (in their content database structures) for any uploaded or hosted content that receives clearance. Thereafter, an attempt to match a new upload or hosted content element will result in a comparison attempt with not only registered content but also previously unregistered content. A match with a registered content entry may, for example, trigger the behavior described above, while a match with an unregistered content entry may still result in a clearance indication but may also trigger a communication with the uploader or hosting web service that advertises the costs and benefits of the CRS service including therein information regarding the cleared match. For example, such advertisement might say “4 posting matches have been detected on YouTube over the past month with 10K+ downloads with your copyright content, which if paid at 25 cents per might yield in excess of $2.5K per month so sign up now.”

Copyright authorship and ownership conflicts might also be detected by the CRS service, which may then for example offer up an environment for resolution. For example, two posters of the same or derivative works might be detected, even on different posting sites. One, both or neither poster may have previously registered with the CRS service. No matter what the scenario, time stamped and stored encounters (i.e., time stamped: content, associated data relating to such content, poster and posting service, etc.) by the CRS service may be offered for sharing in an online portal that assists in settling copyright disputes. Such settlement support may, for example, include a revenue sharing agreement wherein a poster receives a percentage of all future revenue collection due to their posting downloads, even where they are not a copyright owner or are merely a creator of a derivative work. Therein, the owner may retain the remainder less a further allocation to the CRS service. The CRS service may also provide support for adding in legal counsel, and may also provide (binding) arbitration service personal themselves via on-staff counsel.

To assist in derivative processing, comparison algorithms from original works to the alleged derivative may be asserted to yield percentages and copied region identifications. Alleged derivative content posters might also submit their evidence of independent creation, prior authorization/contracts, and such into the settlement portal environment Likewise, the original content owner might submit their evidence of access and claims of substantial similarity, creation dates, etc. If claims and evidence are too complex or extensive, staff arbitrators might not be employed and the negotiation and settlement portal being made available to outside counsel or to support independent poster-owner arrangements. Stock, standard agreements related thereto with corresponding CRS service configurations (e.g., defining revenue collection, distribution and so on) might be applied quickly and easily. For example, the poster and the owner may select and execute one of a series of types of standard agreements, and the CRS service may automatically configure itself regarding the underlying content in predefined conformance with the selection. Interactions between parties may be carried out through an internal mail posting module, text/video chat modules, etc., or via external, third party counterparts.

In addition to storing unregistered entries, large databases of copyrighted content may be copied into the CRS service database in bulk as unregistered entries. For example, Yahoo's entire posting database or active portions thereof might be retrieved for pre-processing and storage into the CRS service database. As before, if one or more matches are found for a particular unregistered work from any posting or hosting, the CRS service may still provide clearance but also use such matching as an enticement to have the underlying copyright owner sign up and agree to pay for future CRS services.

Revenue may, for example, be extracted from one or more of the content owner, poster/uploader/hoster, and content consumer/downloader. Such revenue may then be automatically redistributed to accounts of any of such parties and to the CRS for services rendered. In particular, revenues may, for example, be based on any one or more of (i) cost per upload rejection; (ii) cost per DRM management; (iii) percentage of associated revenue collection; (iv) cost for service sign-up or ongoing basis charges; (v) cost per storage period based on size (bytes) and type; (vi) cost per download approach (streaming versus lower quality of service); (vii) advertising/search hits/support; etc.

For example, an author writes a paper and agrees with IEEE to collect funds and offer up an abstract. CRS makes a deal with IEEE to create digital signatures or watermarks for each of IEEE's underlying papers. CRS may then, for example, step between the upload (or web hosting) and posting (or search results inclusion) processes by first ensuring that all of IEEE's papers are accounted for. In other words, if a user (or web service) attempts to make an IEEE paper available to the public, CRS will detect same and contact the copyright owner (and possibly not IEEE—even though it could do so) to advertise CRS services which includes the detection data (which may then prove more likely to result in a copyright owner's commitment to CRS service). In addition, such contact may indicate upload popularity and use such popularity to focus CRS advertising campaigns. A highly popular content could even, for example, justify a CRS staff telephone call wherein an occasional upload attempt might receive stock email offers. Content without any upload attempts might receive minor CRS contact or none at all. In addition, popularity may be used to automatically select a revenue collection approach most appealing to both the copyright owner and CRS. In addition, CRS may gain further revenue from handling automated or automatic copyright registration around the world as needed by evidence of regional popularity (downloads and/or postings or attempts related thereto). Popularity might also be indicated by search input received by a search infrastructure. Popularity correlates strongly with an ability to monetize content, so CRS may be used to entice popular content owners, posters, hosters, etc. into its highly profitable service offerings. Unpopular content may, for example, be ignored or treated with less complex or less burdensome (for the CRS service and infrastructure) service approaches/models. As popularity changes (becomes less popular), CRS servicing may change the underlying revenue model or terminate service offerings. For example, CRS may have an Agreement with each copyright owner (and possibly with posters and downloaders) that allows for transition from a commonly downloaded funds collection and CRS servicing model to perhaps a long term storage without screening model with only charges for storage. Many other transition configurations of service and revenue collection/sharing may be defined as popularity of underlying content changes. In addition, an owner may select to maintain a minimum or fixed level of service, for example regardless the popularity, by agreeing to a defined cost structure.

In addition to supporting official registration, geographical information may be associated with the CRS service offerings in other ways such as, for example, for: (a) applying regional restrictions; and (b) applying different CRS service behaviors depending on geography of underlying parties. For example, a copyright owner might choose to enable: 1) a first revenue collection approach collecting from each U.S. based poster/hoster and U.S. based content consumer/downloader; 2) a second revenue collection approach for local posters/hosters (e.g., in-town free or low cost downloads); 3) a third revenue collection approach for EU content consumers from U.S. based posts/hosting; and 4) blocking posting/hosting by parties outside of the U.S. and blocking downloading/consuming to anyone outside of the U.S. and EU. An owner may further, for example, enable or block particular individuals or groups as part of such set-up. For example, an owner might allow content posting by a select list of individuals, on a select list of web sites, for content consumption by a select list of other individuals. Owners may, for example, be provided a web and App management interface to manage and guide their content submissions, tailor and launch associated CRS service behaviors, monitor any downloading, consumption and revenue generation activity, etc. In doing so, an owner may easily manage a long list of copyrighted content (original and derivative works) in a combined manner. For example, a large group of content might be uploaded and a single storage with full restrictions and no revenue generation screening approach might be established for every or a plurality of entries simultaneously, and so on. An author may, for example, be provided limited access to only their own content, while an associated owner might have full access spanning perhaps many authors via a combined user interface. Public access to such management data may also be provided (e.g., for browsing or searching) but on a much more limited basis.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences may be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, may be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications maybe practiced within the spirit and scope of the invention, as limited only by the scope of the appended claims.

What is claimed is:

1. A copyright registration and screening system comprising:
a creative work protection module comprising a processing circuit and a memory and being operable to, at least:
receive upload information from a content-hosting site to which a user is attempting to post the upload information;
analyze the received upload information to determine whether the upload information is registered as protected, by at least in part operating to convert the received upload information to a predefined data format, and to perform one or more of the following:
a text data comparison between the converted received upload information and text information registered as protected, where the text data comparison comprises one or both of a comparison of key phrases and a character-by-character comparison;
perform an image data comparison between the converted received upload information and image information registered as protected, where the image data comparison comprises a pixel-by-pixel comparison;
perform an audio data comparison between the converted received upload information and audio information registered as protected, where the audio data comparison comprises a bit-by-bit comparison; and
perform a video data comparison between the converted received upload information and video information registered as protected, where the video data comparison comprises a frame-by-frame comparison;
if it is determined that the upload information is not protected, then approve the upload to the content-hosting site; and
if it is determined that the upload information is protected, then deny the upload to the content-hosting site.

2. The copyright registration and screening system of claim 1, wherein the creative work protection module is operable to, if it is determined that the upload information is protected, contact a copyright owner associated with the protected upload information to provide an offer of content protection services, wherein the contact indicates popularity of attempts to post the upload information.

3. The copyright registration and screening system of claim 1, wherein the creative work protection module is operable to, if it is determined that the upload information is protected, contact the copyright owner by, at least in part, operating to:
determine a popularity of attempts to post the upload information; and
select a manner of contacting the copyright owner based, at least in part, on the popularity of attempts to post the upload information;
contact the copyright owner in the selected manner.

4. The copyright registration and screening system of claim 1, wherein the creative work protection module is operable to, if it is determined that the upload information is protected:
identify an owner of the registered protected information;
generate an output graphical user interface screen showing a side-by-side comparison between the received upload information and the information registered as protected; and
communicate the output graphical user interface screen to the identified owner.

5. The copyright registration and screening system of claim 1, wherein the creative work protection module is operable to provide a protected work registration interface by which a copyright owner may register a protected work, the protected work registration interface comprising a plurality of fields comprising a field by which a registered copyright owner may specify a particular work for upload.

6. The copyright registration and screening system of claim 5, wherein the protected work registration interface is operable to receive information from the copyright owner describing a level of protection to be applied to the protected work.

7. The copyright registration and screening system of claim 5, wherein the protected work registration interface is operable to receive information from the copyright owner describing terms of use for the protected work.

8. The copyright registration and screening system of claim 5, wherein the protected work registration interface is operable to receive only a portion of a copyrighted work that is to be protected.

9. The copyright registration and screening system of claim 5, wherein the protected work registration interface is operable to receive information by which the copyright owner can define geographically-dependent access rules for the protected work.

10. The copyright registration and screening system of claim 1, wherein when a registered protected work is approved for upload, the creative work protection module is operable to associate time and date stamps to the registered protected work.

11. The copyright registration and screen system of claim 1, wherein the creative work protection module is integrated into a peer-to-peer content hosting site.

12. A copyright registration and screening system comprising:
a creative work protection module comprising a processing circuit and a memory and being operable to, at least:
receive uploaded information from a content-hosting site to which the uploaded information has been uploaded;
analyze the uploaded information to determine whether the uploaded information is registered as protected, by at least in part operating to:
separate the uploaded information into at least a text portion and an image portion;
convert the text portion and the image portion into predefined respective data formats;
perform a textual comparison between the received upload information and text information registered as protected, where the textual comparison comprises one or both of a comparison of key phrases and a character-by-character comparison; and
perform an image data comparison between the received upload information and image information registered as protected where the image data comprises a pixel-by-pixel comparison;
if it is determined that the uploaded information is not protected, then approve the upload; and
if it is determined that the uploaded information is protected, then disable user access to the upload.

13. The copyright registration and screening system of claim 12, wherein the creative work protection module is operable to, if it is determined that the uploaded information is protected, contact a copyright owner associated with the uploaded information to provide an offer of content protection services, wherein the contact indicates popularity of attempts to post the upload information.

14. The copyright registration and screening system of claim 12, wherein the creative work protection module is operable to, if it is determined that the uploaded information is protected, communicate an electronic mail message to copyright owner associated with the protected upload information to provide an offer of content protection services, wherein the contact indicates popularity of attempts to post the upload information.

15. The copyright registration and screening system of claim 12, wherein the creative work protection module is operable to, if it is determined that the uploaded information is protected, contact the copyright owner by, at least in part, operating to:
determine a popularity of attempts to post the upload information; and
select a manner of contacting the copyright owner based, at least in part, on the popularity of attempts to post the upload information; and
contact the copyright owner in the selected manner.

16. The copyright registration and screening system of claim 12, wherein the creative work protection module is operable to, if it is determined that the uploaded information is protected:
identify an owner of the registered protected information;
generate an output graphical user interface screen showing a side-by-side comparison between the received upload information and the information registered as protected; and
communicate the output graphical user interface screen to the identified owner.

17. The copyright registration and screening system of claim 14, wherein the creative work protection module is operable to provide a protected work registration interface by which a copyright owner may register only a portion of a protected work.

18. A copyright registration and screening system comprising:
a creative work protection module comprising a processing circuit and a memory and being operable to, at least:
receive upload information from a content-hosting site to which a user is attempting to post the upload information;
analyze the upload information to determine whether the upload information is registered as protected, by at least in part operating to convert the received upload information to a predefined data format, and to perform one or more of the following:
a textual comparison between the converted received upload information and text information registered as protected, where the text data comparison comprises one or both of a comparison of key phrases and a character-by-character comparison;
perform an image data comparison between the converted received upload information and image information registered as protected, where the image data comparison comprises a pixel-by-pixel comparison;
perform an audio data comparison between the converted received upload information and audio information registered as protected, where the audio data comparison comprises a bit-by-bit comparison; and
perform a video data comparison between the converted received upload information and video information registered as protected, where the video data comparison comprises a frame-by-frame comparison; and
if it is determined that the upload information is not protected, then:
approve the upload;
register the upload information associated with the user;
monitor access to the uploaded information; and
based, at least in part, on the monitored access, contact the user regarding copyright protection services for the upload information.

19. The copyright registration and screening system of claim 18, wherein the creative work protection module is operable to determine a communication medium through which to contact the user regarding copyright protection services based, at least in part, on a volume of access to the upload information.

20. The copyright registration and screening system of claim 18, wherein the creative work protection module is operable to, if it is determined that the upload information is protected:
identify an owner of the registered protected information;
generate an output graphical user interface screen showing a side-by-side comparison between the received upload information and the information registered as protected; and
communicate the output graphical user interface screen to the identified owner.
